(19) United States
(12) Patent Application Publication
(10) Pub. No.: US 2002/0045010 A1
(43) Pub. Date: Apr. 18, 2002

(54) Coating compositions for modifying hard surfaces

(75) Inventors: Robert Henry Rohrbaugh, Hamilton, OH (US); Michael Ray McDonald, Middletown, OH (US); John David Carter, Newcastle-Upon-Tyne (GB); Eugene Paul Gosselink, Cincinnati, OH (US); Chanchal Kumar Ghosh, West Chester, OH (US); Glenn Thomas Jordan IV, Indian Springs, OH (US); Helen Frances O'Connor, Loveland, OH (US); Heather Anne Liddle, Cincinnati, OH (US); Marc Francois Evers, Strombeek-Bever (BE)

Correspondence Address: THE PROCTER & GAMBLE COMPANY, PATENT DIVISION, IVORYDALE TECHNICAL CENTER - BOX 474, 5299 SPRING GROVE AVENUE, CINCINNATI, OH, 45217, US

(73) Assignee: The Procter & Gamble Company

(21) Appl. No.: 09/876,363

(22) Filed: Jun. 7, 2001

Related U.S. Application Data
(63) Continuation-in-part of application No. 09/828,014, filed on Apr. 6, 2001.
(60) Provisional application No. 60/265,059, filed on Jan. 30, 2001.

(30) Foreign Application Priority Data
Jun. 14, 2000 (US) PCT/US00/16349

(51) Int. Cl. B05D 3/02; B05D 5/00; C09K 3/00

(52) U.S. Cl. 427/372.2; 106/287.17

(57) ABSTRACT

Materials for coating, coating compositions, methods and articles of manufacture comprising a nanoparticle system or employing the same to impart surface modifying benefits for all types of inanimate hard surfaces are disclosed. In some embodiments, dispersement of nanoparticles in a suitable carrier medium allows for the creation of coating compositions, methods and articles of manufacture that create multi-use benefits to modified hard surfaces. These surface modifications can produce long lasting or semi-permanent multi-use benefits that include at least one of the following improved surface properties: wetting and sheeting, quick drying, uniform drying, soil removal, self-cleaning, anti-spotting, anti-soil deposition, cleaner appearance, enhanced gloss, enhanced color, minor surface defect repair, smoothness, anti-hazing, modification of surface friction, release of actives and transparency, relative to hard surfaces unmodified with such nanoparticle systems. In some embodiments, actively curing the coating composition on the hard surfaces, including, but not limited to by radiative heating the air surrounding the hard surface with the coating thereon can be used to increase the durability of the hard surface coating.

### CROSS-REFERENCE TO RELATED APPLICATIONS

This application claims the benefit of the filing dates of PCT application Serial No. US00/16349, filed Jun. 14, 2000, U.S. Provisional patent application Serial No. 60/265,059, filed Jan. 30, 2001, and U.S. patent application Ser. No. 09/828,014, filed Apr. 6, 2001, which are incorporated by reference herein in their entirety.

### FIELD OF THE INVENTION

The present invention relates to coatings, compositions, methods and articles of manufacture comprising a nanoparticle system or employing the same to impart surface modifying benefits for all types of hard surface applications.

The use of non-photoactive nanoparticles allows for the creation of coatings, compositions, methods and articles of manufacture that create multi-use benefits to modified hard surfaces. These surface modifications can produce durable, long lasting or semi-permanent multi-use benefits that include at least one of the following improved surface properties: wetting and sheeting, quick drying, uniform drying, soil removal, self-cleaning, anti-spotting, anti-soil deposition, cleaner appearance, enhanced gloss, enhanced color, minor surface defect repair, smoothness, anti-hazing, modification of surface friction, release of actives, and transparency (e.g., in the case of glass and the like), relative to hard surfaces unmodified with such nanoparticle systems.

### BACKGROUND OF THE INVENTION

There have been many problems associated with developing hard surface coatings that provide a beneficial layer with the desirable properties and which minimize the disadvantages, such as a limit to single use protection, insufficient coverage, roughness and/or flaking of coating during use, or in contrast, the inability to remove once applied (when a more temporary coating is desired), a limit on surfaces that can be modified, photoactive damage and degradation of the surface, and in the case of TiO₂, the need to photoactivate the coating.

The current approach to solving the coating problem is with the use of surfactants, film-forming polymer coatings, clay-containing-film-forming polymer coatings and photoactive inorganic metal oxide coatings. However, the substantivity of the film-forming polymers (e.g. alkoxylated silicones, poly(N-vinyl-2-pyrrolidones, poly(N-vinyl-imidazoles, diblock copolymers of poly(ethylene oxide) and poly(lactide)) is poor such that its wetting/sheeting effect is short-lived, with spotting/residue negatives returning within 1-2 rinses, exposures to the elements (e.g., rain, etc.), or conditions (e.g., water in a shower). Elevating the levels of polymers is not the solution to this problem. This is especially evident on automobile surfaces, residential windows, building exteriors, shower units and dishware where elevated levels of polymers result in unacceptable residue problem. In the case of clay-containing, film-forming polymer coatings, the nanoparticles are rheology agents for the formulations and do not themselves impart the benefit disclosed. One example of this approach is disclosed in U.S. Pat. No. 5,429,999, titled “Organoclay Compositions Containing Two Or More Cations And One Or More Organic Anions”, wherein preparation and use in non-aqueous systems of an organophilic clay gellant is used in a non-aqueous fluid system such as paints, inks, and coatings to provide improved theological properties. Other related patents include: U.S. Pat. No. 05,785,749, titled “Method For Producing Rheological Additives And Coating Compositions Incorporating Same”; U.S. Pat. No. 05780376, titled “Organoclay Compositions”; U.S. Pat. No. 05,739,087, Titled “Organoclay Products Containing A Branched Chain Alkyl Quaternary Ammonium Ion”; U.S. Pat. No. 05,728,764, titled “Formulations Including Improved Organoclay Compositions”; and U.S. Pat. No. 06,036,765, titled “Organoclay Compositions And Method Of Preparation”.

Another approach to this problem is disclosed in U.S. Pat. No. 4,597,886, titled “Dishwashing Compositions”, wherein an inclusion of an effective level of a layered clay (e.g. a synthetic hectorite) in an enzymatic dishwashing composition is introduced to reduce the formation of spots and films on the cleaned objects. U.S. Pat. No. 4,591,448, titled “Dishwashing Compositions”, discloses the use of a layered clay in a non-enzymatic dish-washing composition with a reduced pH of 9-11 to provide for a reduction of spot and film formation on the cleaned articles. See also U.S. Pat. No. 4,591,449. EP. Pat. No. 139,330 B1, titled “Rinse Aid” discloses the use of a layered clay as a rinse aid or rinse component for the aqueous rinsing step of a machine dishwashing process to provide anti-spotting benefits. In the abovementioned dishware care patents, the layered clay is introduced in the machine dishwashing detergent or rinse aide as a single-use application to prevent spotting and film formation during that particular wash cycle. These patents do not disclose a nanoparticle coating system requirement which is preventative in nature, unlike the present invention. Furthermore, they do not disclose multi-use benefits (such as, anti-spotting, anti-hazing, soil removal and minor surface defect repair) without additional treatment between uses.

The photoactive metal oxide approach using nanoparticles, such as zinc oxide (ZnO₂) and titanium dioxide (TiO₂), have serious limitations and harmful deleterious surface effects to overcome. The potential of using TiO₂ to functionalize hard surfaces (1) is limited to surfaces exposed to outdoor levels of UV and (2) requires special surface safety precautions to protect against photoactivated damage mechanisms. In addition, TiO₂ is difficult to apply to said surfaces and often requires professional treatment of the surface.

In the case of TiO₂ thin films, an approach taken in JP. Pat. No. 11181339 A2, titled “Hydrophilic Coating Composition”, discloses a room-temperature-settable coating composition comprising an aqueous fluid containing photocatalytic titanium oxide particles having a particle diameter of 1-100 nm and tin oxide particles having a particle diameter of 1-100 nm and having a pH of 8-12 or a pH of 0-5, and a coating film which exhibits hydrophilicity when it is formed on a substrate and irradiated with ultraviolet rays at a wavelength of 200-400 nm and, and the photocatalytic titanium oxide is photoexcited. Other related patents disclosing methods and articles of use for the abovementioned titanium oxide coating composition include JP. Pat. No. 11172239 A2, titled “Hydrophilic Member, Method For Hydrophilization/Hydrophilicity Retention Of Surface Of Member, And Hydrophilic Coating Composition”; JP. Pat. No. 10297436 A2, titled “Manufacture Of Mirror For Vehicle With Improved Rainy Weather Visibility”; JP. Pat. No. 10046759 A2, titled “Roof Material Having Ice-Snow Sticking Preventive Performance, JP. Pat. No. 09056549 A2, titled “Anti-Fogging Mirror”; JP. Pat. No. 00128672 A2, titled “Ceramic Ware And Its Production”; JP. Pat. No. 00096800 A2, titled “Antifouling Building Material And Manufacture Thereof”; JP. Pat. No. 11300303 A2, titled “Cleaning Method Of Composite Material And Self-Cleaning Composite Material Mechanism”; JP. Pat. No. 10237431 A2, titled “Member With Ultrawater-Repellent Surface”; JP. Pat. No. 10212809 A2, titled “Building Material For External Wall”; JP. Pat. No. 09230107 A2, titled “Anti-Fogging Glass Lens And Its Anti-Fogging Method”; and JP. Pat. No. 09228072 A2, titled “Outdoor Member”. In the abovementioned patents, the hydrophilic TiO₂ film can cause photo- and chemical-degradation of organic undercoats, and any rubber or plastic it comes into contact with, and requires professional means of application and treatment.

U.S. Pat. No. 4,164,509, titled “Process For Preparing Finely Divided Hydrophobic Oxide Particles” discloses a process for preparing hydrophobic finely divided particles of oxides of metals and/or oxides of silicon by chemically bonding hydrocarbon radicals to the surface of the oxide particles.

It is apparent that there is a continuing need in order to improve the various properties of all hard surfaces, including but not limited to fiberglass, plastics, metals, glass, ceramic, wood, stone, concrete, asphalt, mineral, and painted surfaces, via a coating composition, method of use and article of manufacture which would result in hard surfaces having one or more of the following highly desirable modified surface properties such as improved surface wetting and sheeting, quick drying, uniform drying, soil removal, self-cleaning, anti-spotting, anti-soil deposition, cleaner appearance, enhanced gloss, enhanced color, minor surface defect repair, improved smoothness, anti-hazing properties, modification of surface friction, release of actives, reduced damage to abrasion and improved transparency. There is also a continuing need that these modified surface benefits be made longer lasting than the approach made by the polymer patents or semi-permanent to be more responsive to consumer applications than the approach that utilizes photoactivated coatings alone (e.g. TiO₂).

Nanoparticles have been used for a number of purposes in general coatings, but not for the abovementioned benefits. One example is disclosed in U.S. Pat. No. 4,173,480, titled “Photographic Sheet With Synthetic Hectorite Antistatic Additive As Sizing Or Backcoat”, wherein a polymer film base is coated with a synthetic hectorite clay, specifically Laponite S™. The binder is gelatin, starch or carboxy methylcellulose. The primary benefit here is to impart antistatic properties to the surface. In the present invention, the binder is not required to apply the nanoparticle to the surface.

Another example is disclosed in U.S. Pat. No. 4,868,048, titled “Conductive Sheet Material Having An Aqueous Conductive Composition, wherein certain fractions (i.e., neighborite) are removed from synthetic hectorite before use thereof as a coating with a non-epoxy binder. The primary benefit here is to impart conduction of electric charge to the surface. In the present invention, the binder is not required to apply the nanoparticle to the surface.

Another example is disclosed in JP. Pat. No. 8053558 A2, titled “Anti-Fog Synthetic Resin Film For Agriculture”, wherein colloidal alumina, colloidal silica, anionic surfactant, organic electrolyte and an inorganic layered compound form a film that exhibits sustained anti-fog properties at low- and high-temperatures. Another example is disclosed in JP. Pat. No. 04353438 A2, titled “Transparent Plastic Films With Good Dew And Blocking Preventing Effects”, discloses Li—Mg—Na silicate layers on 1 side of the films useful for greenhouses, book covers, card holders, etc. See also, EP 0732387 titled, “Antifogging agent composition and agricultural film coated therewith”.

Another example is disclosed in U.S. Pat. No. 4,786,558, titled “Composite Film And Antistatic Composite Film Comprising A Swellable Inorganic Silicate”, where the inorganic nanoparticle is modified by treating it with various ions to provide a composite film with antistatic benefits comprising a swellable inorganic silicate.

Another example is disclosed in W.O. Pat. 99/00457 A1, titled “Coating Agent For Reducing The Soiling Process Of Facades”, wherein the invention relates to the preparation of a system used for reducing the soiling process of building facades. Here the layered silicate is disclosed for its use as a gellant and is not responsible for the reduction of surface soiling benefits alone.

Another approach is disclosed in U.S. Pat. No. 5,853,809, entitled “Scratch Resistant Clearcoats Containing Surface Reactive Microparticles and Method Therefor” issued to Campbell, et al. This patent is directed to clearcoat coating compositions that, after application, comprise the outermost layer on automotive body panels. Reactive inorganic microparticles are added to the coating composition to improve scratch resistance.

Another approach taken is disclosed in U.S. Pat. No. 6,020,419, titled “Transparent Coating Compositions Containing Nanoscale Particles And Having Improved Scratch Resistance”, wherein specific combinations of properties in coatings, such as transparency and wear resistance, may be obtained by using nanoparticles.

The present invention relates to materials, coatings, compositions, methods, and articles of manufacture that provide some important hard surface multi-use benefits that can be made durable, long lasting or semi-permanent. These multi-use benefits include at least one of the following: improved surface wetting and sheeting, quick drying, uniform drying, soil removal, self-cleaning, anti-spotting, anti-soil deposition, cleaner appearance, enhanced gloss, enhanced color, minor surface defect repair, improved smoothness, anti-hazing properties, modification of surface friction, release of actives, reduced damage to abrasion, and improved transparency (the latter in the case of surfaces such as glass and the like, particularly after such surfaces are soiled or contacted with water) relative to transparent surfaces that are not treated with the materials, coatings, or coating composition, and anti-fogging in the case of surfaces (such as mirrors) that are designed to reflect.

### SUMMARY OF THE INVENTION

In one embodiment of the present invention there is provided a material for coating a hard surface. As used herein, the term “coating” includes coatings that completely cover a surface, or portion thereof, as well as coatings that may only partially cover a surface, such as those coatings that after drying leave gaps in coverage on a surface. The later category of coatings may include, but is not limited to a network of covered and uncovered portions (e.g., non-continuous covered regions of the surface). When the coatings described herein are described as being applied to a surface, it is understood that the coatings need not be applied to, or that they cover the entire surface. For instance, the coatings will be considered as being applied to a surface even if they are only applied to modify a portion of the surface.

The material for coating a hard surface can comprise a plurality of non-photoactive nanoparticles, or it can comprise a hard surface coating composition. Such a coating composition may comprise: (a) an effective amount of non-photoactive nanoparticles; (b) optionally a surfactant; (c) optionally having associated to said nanoparticle surface a quantity of one or more functionalized surface molecules exhibiting properties selected from the group consisting of hydrophilic, hydrophobic and mixtures thereof; (d) optionally one or more adjunct ingredients; and (e) optionally a suitable carrier medium.

In another embodiment of the present invention, there is provided a method of applying a substantially clear coating to a hard surface comprising: applying a material comprising an effective amount of non-photoactive nanoparticles to the hard surface; and, actively curing the material to form a coating on the hard surface.

In another embodiment of the present invention there is provided a method of using a coating composition by (a) mixing said nanoparticles in suitable carrier medium to form said coating composition; (b) optionally mixing said nanoparticles dispersed in suitable carrier medium with adjunct ingredients to form said coating composition; (c) optionally mixing said nanoparticles dispersed in suitable carrier medium with surfactant to form said coating composition; (d) optionally mixing said nanoparticles dispersed in suitable carrier medium with adjunct ingredients and surfactant to form said coating composition; (e) applying said coating composition to a hard surface; (f) allowing said coating composition to dry, or drying the coating composition; and (g) optionally repeating any of steps (a) through (f) as needed.

The drying step can comprise air drying in ambient conditions, or it can comprise actively drying the coating composition by utilizing any technology known for accelerating the drying process. It has been found the heat drying the hard surface coating composition can greatly increase the durability of the hard surface coating.

In another embodiment of the present invention there is provided an article of manufacture comprising an applicator, such as a spray dispenser, an immersion container, a hose spray dispenser attachment, a fabric or a porous article, such as a sponge; further comprising (a) a coating composition, wherein said coating composition is in the physical form selected from the group consisting of liquid, liquid concentrate, gel, powder, tablet, granule and mixtures thereof; (b) optionally a source of water or deionized water; and (c) optionally a set of instructions in association with said spray dispenser comprising an instruction to dispense said coating composition from said spray dispenser onto said hard surface.

In another embodiment of the present invention there is provided a treated hard surface coated with the coating composition. Substrates treated with the benefit agent materials of the present invention exhibit a greater improvement in wetting and sheeting, quick drying, uniform drying, soil removal, self-cleaning, anti-spotting, anti-soil deposition, cleaner appearance, enhanced gloss, enhanced color, minor surface defect repair, improved smoothness, anti-hazing properties, modification of surface friction, release of actives, reduced damage to abrasion and improved transparency than substrates treated without such benefit agent materials.

In another embodiment of the invention there is provided a treated hard surface coated with a coating composition, where the coating composition is strippable. Substrates treated with the benefit agent materials of the present invention exhibit a greater improvement in soil removal, self-cleaning, anti-spotting, anti-soil deposition, cleaner appearance after at least one effective nanoparticle layer has been stripped than substrates treated without such benefit agent materials.

Numerous other embodiments are also possible. These elements of the embodiments described herein can also be combined in other ways, or with other elements to create still further embodiments.

All percentages, ratios and proportions herein are on a weight basis based on a neat product unless otherwise indicated. All documents cited herein are hereby incorporated by reference.

### BRIEF DESCRIPTION OF THE DRAWINGS

While the specification concludes with claims particularly pointing out and distinctly claiming the subject matter which is regarded as forming the present invention, it is believed that the invention will be better understood from the following description taken in conjunction with the accompanying drawings, in which:

FIG. 1 is a schematic side view of a hard surface with several layers of nanoparticles that form a coating thereon, and soil on a portion of the nanoparticle coating.

FIG. 2 is a schematic side view similar to FIG. 1, only showing how the removal of the top layer of nanoparticles may remove the soil deposited on the coating.

FIG. 3 is a schematic side view similar to FIGS. 1 and 2 showing a further step in the removal process.

FIG. 4 is a flow diagram showing the steps in one embodiment of a clear coat application process for use in the automotive industry.

FIG. 5 is a photograph taken by atomic force microscopy of a non-limiting example of a nanoparticle coating which provides effective hydrophilic modification of a surface wherein the image on the left side represents the topography of the treated sample, and the image on the right side represents the phase of the treated sample.

FIG. 6 is a photograph taken by atomic force microscopy of a non-limiting example of a nanoparticle coating which provides considerably less effective hydrophilic modification of a surface wherein the image on the left side represents the topography of the treated sample, and the image on the right side represents the phase of the treated sample.

### DETAILED DESCRIPTION OF THE INVENTION

### Hard Surfaces

Fiberglass surfaces comprise resins, polymers, reinforcing fabric and fibers. Hard surfaces made from fiberglass include but are not limited to bathtubs, boats, motorcycles, car bodies, canoes, airplanes, model aircraft, jet skis, sculptures, as well as traditional industrial molding and model-making articles.

There are seven basic types of hard surface plastics which include polyethylene terephthalate (PET), high density polyethylene (HDPE), polyvinyl chloride (PVC), low density polyethylene (LDPE), polypropylene (PP), polystyrene (PS), polymers and mixtures thereof. These types of plastics may also be combined with other materials including, but not limited to nanoparticles, to make all sorts of composites. Manufacturers are unlimited in the number and types of articles that can be made from plastic. Carbon and graphite fibers are high-strength materials that are used as reinforcing agents in plastic composites. Examples of plastic articles include bottles, jars, jugs, bags, covers, pipes, furniture, containers, caps, cups, trays, aircraft fuselages and wings, spacecraft structures, and sports equipment.

Both ferrous and nonferrous metal surfaces are available for use with this invention. These include aluminum, brass, bronze, chrome, copper, tin, zinc, iron, stainless steel and steel. Examples of metal surfaces include (e.g. buildings, doors, window frames, automobiles, boats, structures, and many more too numerous to mention).

There are three basic types of glass-sheet, plate, and float. These basic glass types can be changed to meet modem requirements for comfort, security, safety, and architectural needs by adding chemicals or other ingredients during fabrication and processing.

There are a number of distinct dishware surface types available. Dishware can include glassware, ceramic ware, plastic ware, wood ware and metal ware. Examples of dishware include agateware, basalt, bisque, bone china, cauliflower ware, cream ware, delft, earthenware, flambe, hard paste porcelain, ironstone, jackfield, jasper, lusterware, majolica, marbled, parian, pate-sur-pate, pearl ware, porcelain, redware, salt glaze, slipware, snowman-porcelain, soft paste porcelain, spatter ware, staffordshire figures, stoneware, tortoiseshell, and transfer ware. Utensils can also be made from any of the above materials.

Ceramic surfaces include glazed tile, mosaic tile, and quarry tile. Applications of ceramic tiles include countertops, walls, floors, ceilings and appliances.

Other types of surfaces, such as sinks, bath tubs, and toilets may be made of porcelain, ceramic, or other materials.

There are many types of wood surfaces available. Examples of some types of wood include wood surface is selected from the group consisting of alder, ash, aspen, beech, birch, bocote, bubinga, butternut, cedar, cherry, cocobolo, canarywood, cypress, ebony, hickory, holly, kingwood, lacewood, locust, mahogany, maple, oak, osage, parawood, padauk, pecan, persimmon, poplar, purpleheart, redheart, rosewood, spanish cedar, sycamore, teak, tulipwood, walnut, wenge, zebrawood, ziricote. Articles made from wood can include furniture, baseball bats, chairs, stools, furniture, handles, motor-vehicle parts, barrels and crates, sporting and athletic goods, railroad ties, veneer, flooring, treated lumber, such as that used for decks, siding, crates, and interior finishing.

There are three basic types of stone surfaces available- igneous, metamorphic and sedimentary. Some of these surfaces include granite, marble, slate, sandstone, serpentinite, schistose gneiss, quartzite, sandstone, limestone and fieldstone. Stone is often used in construction of buildings, roads, walls, fireplaces and monuments. There are a number of types of concrete surfaces available as well. These surfaces include unreinforced concrete, reinforced concrete, cast-in-place concrete, precast concrete, post-tensioned concrete, and prestressed concrete. Examples of concrete surfaces include building components, bridge components, walls, streets, curbs and gutters. Asphalt comes in four types- hot-mix asphalt, cold-mix asphalt, glassphalt and rubberized asphalt. Asphalt is used on road surfaces, walls, roofing and sporting tracks. There are a multitude of mineral surfaces available. Minerals comprise ores of metal and other natural substances that can be mined. Examples of mineral surfaces may include jewelry, furniture, building components and many more. Finally coated and painted surfaces are also examples of hard surfaces that can be modified by the present invention to derive the desired benefits.

In certain aspects, the hard surfaces described herein are preferably rigid (not flexible). Examples of surfaces that are not considered to be rigid would include films. In certain aspects, the surfaces described herein are more rigid than a synthetic resin film having a thickness of 0.1 mm.

In certain aspects, it is desirable for the coating compositions to be applied to exposed surfaces. As used herein, the term “exposed surfaces” includes exterior surfaces that are exposed to the elements. In certain aspects, the coating compositions are applied to interior surfaces that are subject to periodic contact with water (including, but not limited to the bathroom surfaces described above). Interior surfaces that are subject to periodic active contact with water may be distinguished from interior surfaces on which water or condensation merely passively accumulates, based on the fact that the former may have water showered, rinsed, or splashed thereon.

In certain aspects, the hard surfaces described herein need not be transparent. That is, the surfaces may be translucent or opaque.

### Nanoparticle System

The nanoparticle system comprises a surface modifying agent comprising a plurality of non-photoactive nanoparticles. The nanoparticle systems may be distinguished from colloids (small particles suspended in solution) in that the nanoparticles are capable of forming a coating or layer after the composition is applied to a surface, whereas colloids are typically only thought of as being dispersed in another media.

The nanoparticle system can comprise materials, compositions, devices, appliances, procedures, methods, conditions, etc. serving a common purpose of modification of hard surfaces to bring about the desired multi-use benefits of improved wetting and sheeting, quick drying, uniform drying, soil removal, self-cleaning, anti-spotting, anti-soil deposition, cleaner appearance, enhanced gloss, enhanced color, minor surface defect repair, improved smoothness, anti-hazing properties, modification of surface friction, release of actives, reduced damage to abrasion and improved transparency.

Nanoparticles, defined as particles with diameters of about 400 nm or less, are technologically significant, since they are utilized to fabricate structures, coatings, and devices that have novel and useful properties due to the very small dimensions of their particulate constituents. Nanoparticles with particle sizes ranging from about 1 nm to about 400 nm can be economically produced. Particle size distributions of the nanoparticles in the present invention may fall anywhere within the range from about 1 nm, or less, to less than about 400 nm, alternatively from about 1 nm to less than about 100 nm, and alternatively from about 1 nm to less than about 50 nm. For example, a layer synthetic silicate can have a mean particle size of about 25 nanometers while its particle size distribution can generally vary between about 10 nm to about 40 nm. Alternatively, nanoparticles can also include crystalline or amorphous particles with a particle size from about 1, or less, to about 100 nanometers, alternatively from about 1 to about 50 nanometers. Nanotubes can include structures up to 1 centimeter long, alternatively with a particle size from about 1, or less, to about 50 nanometers.

Inorganic nanoparticles generally exist as oxides, silicates, carbonates and hydroxides. Some layered clay minerals and inorganic metal oxides can be examples of nanoparticles. The layered clay minerals suitable for use in the present invention include those in the geological classes of the smectites, the kaolins, the illites, the chlorites, the attapulgites and the mixed layer clays. Typical examples of specific clays belonging to these classes are the smectites, kaolins, illites, chlorites, attapulgites and mixed layer clays. Smectites, for example, include montmorillonite, bentonite, pyrophyllite, hectorite, saponite, sauconite, nontronite, talc, beidellite, volchonskoite and vermiculite. Kaolins include kaolinite, dickite, nacrite, antigorite, anauxite, halloysite, indellite and chrysotile. Illites include bravaisite, muscovite, paragonite, phlogopite and biotite. Chlorites include corrensite, penninite, donbassite, sudoite, pennine and clinochlore. Attapulgites include sepiolite and polygorskyte. Mixed layer clays include allevardite and vermiculitebiotite. Variants and isomorphic substitutions of these layered clay minerals offer unique applications.

The layered clay minerals of the present invention may be either naturally occurring or synthetic. An example of one embodiment of the present invention uses natural or synthetic hectorites, montmorillonites and bentonites. Another embodiment uses the hectorites clays commercially available, and typical sources of commercial hectorites are the Laponites from Southern Clay Products, Inc., U.S.A; Veegum Pro and Veegum F from R. T. Vanderbilt, U.S.A.; and the Barasyms, Macaloids and Propaloids from Baroid Division, National Read Comp., U.S.A.

The inorganic metal oxides of the present invention may be silica- or alumina- based nanoparticles that are naturally occurring or synthetic. Aluminum can be found in many naturally occurring sources, such as kaolinite and bauxite. The naturally occurring sources of alumina are processed by the Hall process or the Bayer process to yield the desired alumina type required. Various forms of alumina are commercially available in the form of Gibbsite, Diaspore, and Boehmite from manufactures such as Condea.

Natural Clays—Natural clay minerals typically exist as layered silicate minerals and less frequently as amorphous minerals. A layered silicate mineral has SiO₄ tetrahedral sheets arranged into a two-dimensional network structure. A 2:1 type layered silicate mineral has a laminated structure of several to several tens of silicate sheets having a three layered structure in which a magnesium octahedral sheet or an aluminum octahedral sheet is sandwiched between two sheets of silica tetrahedral sheets.

A sheet of an expandable layer silicate has a negative electric charge, and the electric charge is neutralized by the existence of alkali metal cations and/or alkaline earth metal cations. Smectite or expandable mica can be dispersed in water to form a sol with thixotropic properties. Further, a complex variant of the smectite type clay can be formed by the reaction with various cationic organic or inorganic compounds. As an example of such an organic complex, an organophilic clay in which a dimethyldioctadecyl ammonium ion(a quaternary ammonium ion) is introduced by cation exchange and has been industrially produced and used as a gellant of a coating.

Synthetic Clays—With appropriate process control, the processes for the production of synthetic nanoscale powders (i.e. synthetic clays) does indeed yield primary particles, which are nanoscale. However, the particles are not usually present in the form of discrete particles, but instead predominantly assume the form of agglomerates due to consolidation of the primary particles. Such agglomerates may reach diameters of several thousand nanometers, such that the desired characteristics associated with the nanoscale nature of the particles cannot be achieved. The particles may be deagglomerated, for example, by grinding as described in EP-A 637,616 or by dispersion in a suitable carrier medium, such as water or water/alcohol and mixtures thereof.

The production of nanoscale powders such as layered hydrous silicate, layered hydrous aluminum silicate, fluorosilicate, mica-montmorillonite, hydrotalcite, lithium magnesium silicate and lithium magnesium fluorosilicate are common. An example of a substituted variant of lithium magnesium silicate is where the hydroxyl group is partially substituted with fluorine. Lithium and magnesium may also be partially substituted by aluminum. In fact, the lithium magnesium silicate may be isomorphically substituted by any member selected from the group consisting of magnesium, aluminum, lithium, iron, chromium, zinc and mixtures thereof.

Synthetic hectorite was first synthesized in the early 1960's and is now commercially marketed under the trade name Laponite™ by Southern Clay Products, Inc. There are many grades or variants and isomorphous substitutions of Laponite™ marketed. Examples of commercial hectorites are Lucentite SWN™, Laponite S™, Laponite XLS™, Laponite RD™ and Laponite RDS™. One embodiment of this invention uses Laponite XLS™ having the following characteristics: analysis (dry basis) SiO₂ 59.8%, MgO 27.2%, Na₂ O 4.4%, Li₂ O 0.8%, structural H₂ O 7.8%, with the addition of tetrasodium pyrophosphate (6%); specific gravity 2.53; bulk density 1.0.

Synthetic hectorites, such as Laponite RD™, do not contain any fluorine. An isomorphous substitution of the hydroxyl group with fluorine will produce synthetic clays referred to as sodium magnesium lithium fluorosilicates. These sodium magnesium lithium fluorosilicates, marketed as Laponite™ and Laponite S™, contain fluoride ions of approximately 5% by weight. Laponite B™, a sodium magnesium lithium flurosilicate, has a flat, circular plate-like shape, and a mean particle size of about 25 nanometers in length (diameter) and about 1 nanometer in thickness. Another variant, called Laponite S™, contains about 6% of tetrasodium polyphosphate as an additive. In some instances, Laponite B™ by itself is believed, without wishing to be bound to any particular theory, to be capable of providing a more uniform coating (that is, more continuous, i.e., less openings in the way the coating forms after drying), and can provide a more substantive (or durable) coating than some of the other grades of Laponite™ by themselves (such as Laponite RD™). The coating preferably forms at least one layer of nanoparticles on the surface which has been coated, and is substantially uniform.

Laponite™ has the formula:

[Mg_{w}LiₓSi₈O₂₀OH_{4-y}F_{y}]²⁻

wherein w=3 to 6, x=0 to 3, y=0 to 4, z=12−2w-x, and the overall negative lattice charge is balanced by counter-ions; and wherein the counter-ions are selected from the group consisting of selected Na⁺, K⁺, NH₄⁺, Cs⁺, Li⁺, Mg⁺⁺, Ca⁺⁺, Ba⁺⁺, N(CH₃)₄⁺ and mixture thereof.

Depending upon the application, the use of variants and isomorphous substitutions of Laponite™ provides great flexibility in engineering the desired properties of the coating composition of the present invention. The individual platelets of Laponite™ are negatively charged on their faces and possess a high concentration of surface bound water. When applied to a hard surface, the hard surface is hydrophilically modified and exhibits surprising and significantly improved wetting and sheeting, quick drying, uniform drying, anti-spotting, anti-soil deposition, cleaner appearance, enhanced gloss, enhanced color, minor surface defect repair, improved smoothness, anti-hazing properties, modification of surface friction, release of actives, reduced damage to abrasion and improved transparency properties. In addition, the Laponite™ modified surface exhibits some “self-cleaning” properties (dirt removal via water rinsing, e.g. from rainwater) and/or soil release benefits (top layers are strippable via mild mechanical action). The hydrophilicity can also provide the exposed layer of nanoparticles with resistance to soiling by hydrophobic types of soils.

In contrast to hydrophilic modification with organic polymers, benefits provided by Laponite™, either alone or in combination with a charged modifier, are longer lived. For example, sheeting/anti-spotting benefits are maintained on an automobile body and glass window after multiple rinses versus one rinse with tap water or rainwater versus on a surface coated with current hydrophilic polymer technology.

Inorganic Metal Oxides—Inorganic metal oxides generally fall within two groups-photoactive and non-photoactive nanoparticles. General examples of photoactive metal oxide nanoparticles include zinc oxide and titanium oxide. Photoactive metal oxide nanoparticles require photoactivation from either visible light (e.g. zinc oxide) or from UV light (TiO₂). Zinc oxide coatings have generally been used as anti-microbial agents or as anti-fouling agents.

Titanium dioxide is taken to be rutiles, anatases and amorphous titanium dioxide having a particle size of 1 to 100 nm, alternatively of 1 to 10 nm, or titanium dioxide having the above-stated particle size in dispersed form. A range of interesting industrial applications for such titanium dioxide particles is beginning to emerge: as a photoactive UV screening agent in cosmetics, plastics, silicone resins and lacquers, wherein the transparency due to the small particle size is a particularly desirable characteristic of the particles; as a flame retardant and to increase the refractive index of silicones and plastics, as described in FR 2 682 369; in protection to degrade organic pollutants, including halogenated pollutants, in waste waters by photocatalysis; to accelerate the decomposition of (bio)degradable polymers; as a support material for novel dye solar cells, as are described, for example, in PCT-WO 93/20569; together with SiO₂ produced using the same method, as a component in special glasses (JP. Pat. No. 10,297,436 A2).

Non-photoactive metal oxide nanoparticles do not use UV or visible light to produce the desired effects. Examples of non-photoactive metal oxide nanoparticles include silica and alumina.

It is possible using the sol/gel process, starting from metal alkoxides, to produce particles having an average diameter of below 50 nm by a controlled increase in molecular weight. Such systems are used, for example, as coating compositions or active substance precursors as described, e.g., in The Polymeric Materials Encyclopedia 1996, volume 6, 4782-4792 et seq.).

Nanoscale metal oxide sols are usually 10 to 50% colloidal solutions of metal oxides (Si, Al, Ti, Zr, Ta, Sn, Zn) having average particle sizes of 2 to about 50 nm in aqueous or organic media. Organophilic particles of a metal oxide chosen from alumina (Al₂O₃), silica (SiO₃), titanium (TiO₂) in which process an aqueous-alcoholic suspension of metal oxide particles have no pores less than 5 nm in diameter at their surface. It is possible to prevent such metal oxide sols from agglomerating by electric and/or steric stabilization of the particle surfaces. Aqueous silica sols may in particular be mentioned, which may be produced, for example, from alkaline solutions by ion exchange processes (for example Ullmann's Encyclopedia of Industrial Chemistry, 5^{th} edition, volume A23, VCH-Verlag, Weinheim, 1993, pp. 614-629). Such products are commercially available, for example under trade names such as Levasil (Bayer AG).

Boehmite alumina is a water dispersible, inorganic metal oxide having a mean particle size of about 25 nanometers in diameter and about 2-4 nanometers in thickness. Such product is commercially available, for example, under the trade name Disperal P2™.

Prior art disclosures have shown it is possible to coat cellulosic materials with colloidal silica sols. In the past, generally dilute aqueous solutions of colloidal silica and urea for non-skid surface compositions for paper products, especially paperboard containing recycled paper fibers, are disclosed in U.S. Pat. Nos. 4,418,111 and 4,452,723 Carstens (assigned to Key Tech Corporation). The use of colloidal silica sols to coat paper in order to provide slip resistance is disclosed in U.S. Pat. Nos. 2,643,048 and 2,872,094.

Inorganic metal oxide nanoparticle provide an additional benefit above those of the layered clays where concentrated sols of inorganic metal oxides can be prepared without gelling. This is particularly advantageous for applications that utilize a dilution step prior to application of the coating composition. Additionally, inorganic metal oxide nanoparticles can provide tolerance to hard water used in making nanoparticle dispersions, diluting nanoparticles dispersion compositions, and the application of nanoparticle compositions wherein the surface contains hard water ions.

Colloidal silica sols have also been employed to impart stiffness to paper and generally for the treatment of paper as disclosed in U.S. Pat. Nos. 2,883,661; 2,801,938; 2,980,558 and other patents.

### Charged Functionalized Molecules

In the present invention, one or more charged functionalized surface molecules may comprise at least two different types of functionalized surface molecules. Furthermore, charged functionalized surface molecules are selected from the group consisting of polymers, copolymers, surfactants and mixtures thereof. Functionalized surface molecules can also be selected from the group consisting of multi-valent inorganic salts consisting of Ca⁺², Mg⁺², Ba⁺², Al⁺³, Fe⁺², Fe⁺³, Cu⁺² and mixtures thereof, where an appropriate anion is used to balance the charge.

In application, hydrophilic modification can be augmented via use of Laponite™ as a basecoat or primer and then treating the negatively charged surface with functionalized charged molecules as a two-step process. Specifically, sequential layering of Laponite™ and ethoxylated, quaternized oligoamines results in a reduction in the contact angles, and enhanced sheeting/wetting of the treated surface. Moreover, if the charged functionalized molecule species possess a lipophilic component, the Laponite treated surface can be hydrophobically modified. Net, the combination of nanoclay plus charge functionalized molecules provides a novel technique for tailoring the hydrophilic/lipophilic character of a hard surface.

Similarly, hydrophilic modification can be augmented via use of alumina as a basecoat or primer and then treating the positively charged surface with functionalized charged molecules as a two-step process. Specifically, sequential layering of alumina and hydrophilic anionic polymers results in enhanced sheeting/wetting of the treated surface. Moreover, if the charged functionalized molecule species possess a lipophilic component, the alumina treated surface can be hydrophobically modified. Net, the combination of inorganic metal oxides plus charge functionalized molecules provides a novel technique for tailoring the hydrophilic/lipophilic character of a hard surface.

I. Composition

If the coating is in the form of a composition, the coating composition may be in any form, such as liquids (aqueous or non-aqueous), granules, pastes, powders, spray, foam, tablets, gels, and the like. Granular compositions can be in “compact” form and the liquid compositions can also be in a “concentrated” form. The coating compositions of the present invention encompass compositions that are used on any suitable hard surface including, but not limited to: fiberglass, plastics, metals, glass, ceramic, wood, stone, concrete, asphalt, mineral, coated surfaces, painted surfaces and mixtures thereof.

In one embodiment, the hard surface coating composition comprises: (a) an effective amount of non-photoactive nanoparticles; (b) optionally one or more adjunct ingredients; and (c) optionally a suitable carrier medium.

In another embodiment, the hard surface coating composition comprises: (a) an effective amount of non-photoactive nanoparticles; (b) a surfactant; (c) optionally one or more adjunct ingredients; and (d) a suitable carrier medium.

Alternatively, an effective amount of one or more nanoparticles described above are included in compositions useful for coating a variety of hard surfaces in need of treatment. As used herein, “effective amount of one or more nanoparticles” refers to the quantity of nanoparticles of the present invention described hereinbefore necessary to impart the desired hard surface coating benefit in the specific composition (for example, an amount effective to provide a residual hydrophilic coating on a surface). Such effective amounts are readily ascertained by one of ordinary skill in the art and is based on many factors, such as the particular nanoparticle used, the hard surface coating application, the specific composition of the hard surface coating composition, and whether a liquid or dry (e.g., granular, powder) composition is required, and the like.

An effective amount of a non-photoactive nanoparticles in the present invention, such as a natural clay, synthetic clay or an inorganic metal oxide, requires that at least 10% of the target surface is modified to effect the desired benefits.

The concentration of nanoparticles in the material or the compositions described herein can range all the way up to 100%. A non-limiting example of the use of nanoparticles in such a high concentration would be if the nanoparticles alone were applied in the form of a powder to the surface to be treated.

The nanoparticle coating compositions described herein can provide the desired performance on surfaces, including vertical surfaces, even when relatively small quantities of the composition are used. For example, it is possible to coat a vertical surface with the nanoparticle coating composition in amounts of less than or equal to about 25 micrograms of nanoparticles/cm² of the surface, or alternatively any number of micrograms less than 25 (e.g., 20, 15, 10, 5, 0.5, etc.). In other alternatives, the coat weight of nanoparticles on the surface can be expressed in terms of a range, including but not limited to any range of numbers, without the need for specifying the same, that is less the above coat weight (25 micrograms of nanoparticles/cm²). The coating compositions can, as a result, be applied in the more convenient and economical form of a dilute liquid, rather than as a gel. The coating compositions in such embodiments, since applied as a thin layer, will quickly dry on the surface, and will not run or drip down a vertical surface. (Of course, in other embodiments, higher coat weights could be used.)

In one non-limiting aspect of the present invention, the concentration of nanoparticles in the coating composition prior to application to a hard surface is less than or equal to about 50% by weight of the coating composition, or any number less than 50% of the weight of the coating composition (e.g., less than or equal to about 20% to less than or equal to about 1%, or less, for example when the coating composition is a liquid that is to be sprayed onto the hard surface; alternatively, less than or equal to about 0.5%, alternatively less than or equal to about 0.1%).

In one aspect of the present invention, the coating composition is prepared by dispersing the dry nanoparticle powder into deionized water to form a 1% concentrated mixture. This mixture is then applied to said surface by either spraying, dipping, painting, wiping, or other manner in order to deliver a coating, especially a transparent coating that covers at least 10% and/or alternatively at least 30% and/or alternatively at least 50% and/or alternatively at least 80% and/or alternatively at least 100% of said surface.

In another embodiment of the present invention, the coating composition is prepared by diluting a nanoparticle gel with deionized water to form a 1% concentrated mixture. This mixture is then applied to said surface by either spraying, dipping, painting, wiping, or other manner in order to deliver a transparent coating that covers at least 10% and/or alternatively at least 30% and/or alternatively at least 50% and/or alternatively at least 80% and/or alternatively at least 100% of said surface.

In another embodiment of the present invention, the coating composition is prepared by diluting a 10% concentrated boehmite alumina (e.g. Disperal P2™ from Condea, Inc.) coating composition with deionized water to form a 0.1% concentrated mixture. This mixture is then applied to said surface by either spraying, dipping, painting, wiping, or other manner in order to deliver a coating especially a transparent coating that covers at least 10% and/or alternatively at least 30% and/or alternatively at least 50% and/or alternatively at least 80% and/or alternatively at least 100% of said surface.

In another embodiment of the present invention, the coating composition is prepared by diluting a 1% concentrated sodium magnesium lithium fluorosilicate (e.g. Laponite B™ from Southern Clay Products, Inc.) coating composition with deionized water to form a 0.1% concentrated mixture. This mixture is then applied to said surface by either spraying, dipping, painting, wiping, or other manner in order to deliver a coating especially a transparent coating that covers at least 10% and/or alternatively at least 30% and/or alternatively at least 50% and/or alternatively at least 80% and/or alternatively at least 100% of said surface.

In another embodiment of the present invention, the coating composition is prepared by diluting a 1% concentrated lithium magnesium sodium silicate (e.g. Lucentite SWN™ from Kobo Products, Inc.) coating composition with deionized water to form a 0.1% concentrated mixture. This mixture is then applied to said surface by either spraying, dipping, painting, wiping, or other manner in order to deliver a coating especially a transparent coating that covers at least 10% and/or alternatively at least 30% and/or alternatively at least 50% and/or alternatively at least 80% and/or alternatively at least 100% of said surface.

In another embodiment of the present invention, the coating composition is prepared by dispersing the dry nanoparticle powder into deionized water to form a 0.1% concentrated mixture. This mixture is then applied to said surface by either spraying, dipping, painting, wiping, or other manner in order to deliver a coating especially a transparent coating that covers at least 10% and/or alternatively at least 30% and/or alternatively at least 50% and/or alternatively at least 80% and/or alternatively at least 100% of said surface.

In other embodiments, the coating composition is prepared by dispersing the dry nanoparticle powder with a surfactant and a dispersant into tap water, so that the use of deionized water is not necessary. Two non-limiting examples of such a coating composition are provided in the Examples section at the end of this description. Examples of other suitable dispersants include, but are not limited to: poly (acrylic/allyl alcohol), poly (acrylic/maleic), poly (a-hydroxyacrylic acid) poly (tetramethylene-1,2- dicarbocylic acid), poly (4-methocy-acid), -tetramethylene-1,2-dicarbocylic acid)-sodium tripolyphosphate, pyrophosphate, and the other dispersants and builders described herein. This mixture is then applied to said surface by either spraying, dipping, painting, wiping, or other manner in order to deliver a coating especially a transparent coating that covers at least 10% and/or alternatively at least 30% and/or alternatively at least 50% and/or alternatively at least 80% and/or alternatively at least 100% of said surface.

In one non-limiting aspect, an effective amount of charged functionalized surface molecules that provide hydrophobic properties to the nanoparticle surface, generally modifies from about 1% to about 100% of the nanoparticle surface or from about 0.01 to about 5% by weight of the coating composition.

In other embodiments, rather than modifying the characteristic of the surface to be coated, the charged functionalized molecules can be used to aid in the delivery of the nanoparticles to the surface to be coated. For instance, in one non-limiting embodiment, a surfactant could be mixed with the nanoparticles in order to aid in the delivery of the nanoparticles to the surface to be coated in cases in which it is difficult to combine the nanoparticle coating with another carrier medium, or in which it is difficult to apply the nanoparticles to a particular surface. For example, if the nanoparticles are to be used with an organic clearcoat composition, it may be difficult to suspend the nanoparticles in the clearcoat composition, or to spread the nanoparticle coating on the surface of such a clearcoat composition. In such a case, the addition of a relatively small amount of surfactant (e.g., virtually any amount of surfactant or functionalized molecules, for example a stoichiometric amount) to the nanoparticles, will aid in overcoming these difficulties. In such a case, the amount of charged functionalized molecules can be less than about 0.01% of the coating composition.

Several non-limiting examples of various coatings and coating compositions wherein the nanoparticles of the present invention may be employed are discussed in further detail below. Also, the coating compositions may include from about 0.001% to about 99.999%, alternatively from about 0.01% to about 99.99% by weight of the coating composition of the adjunct materials. In certain embodiments, the coating composition comprises less than or equal to about 10% (or less than about 10%) by weight of other ingredients other than the nanoparticles and the carrier medium, alternatively, less than or equal to any percentage less than 10 (e.g., less than or equal to about 5%, alternatively less than or equal to about 1%), of other ingredients.

As used herein, the coatings and “coating compositions” include hand and machine applied coatings, compositions, including additive coatings, additive compositions, and compositions suitable for use in the soaking and/or pretreatment of unclean or stained hard surfaces. The coatings, coating compositions and/or methods and/or articles of manufacture of the present invention are for all uses including manufacturing, commercial, industrial, institutional, agricultural and/or for domestic use.

When the coating compositions are formulated as compositions suitable for use in an enumerated method or article of manufacture, the coating compositions of the present invention alternatively contain both an effective amount of nanoparticles and a suitable carrier medium to form the nanoparticle system and may optionally include one or more of the following: a surfactant, a quantity of one or more charged functionalized surface molecules, photoactive nanoparticles, and one or more adjunct ingredients.

The coating compositions of the present invention can also be used as detergent additive products in solid or liquid form. Such additive products are intended to supplement or boost the performance of conventional coating compositions used to clean hard surfaces and can be added at any stage of the cleaning process, however addition of the transparent hard surface coating composition to a clean surface is more effective.

Aqueous liquid, coating compositions according to the present invention can also be in a “concentrated form”, in such case, the concentrated liquid, coating compositions according the present invention will contain a lower amount of a suitable carrier medium, compared to conventional liquid, coating compositions. Typically the suitable carrier medium content of the concentrated system, hard surface coating composition is alternatively 99.99 to 50% by weight of the coating composition.

Aqueous liquid, coating compositions according to the present invention can also be in a “concentrated form” that is compatible with “tap water”, in such case, the concentrated liquid, coating compositions according the present invention will contain a lower amount of a suitable carrier medium, compared to conventional liquid, coating compositions and a dispersant. Typically the suitable carrier medium content of the concentrated system, hard surface coating composition is alternatively 99.99 to 50% by weight of the coating composition. Typically the dispersant content of the concentrated system, hard surface coating composition is alternatively 0.001 to 10 %.

The present invention comprises liquid (a compatible carrier), coating compositions, alternatively aqueous liquid (a compatible carrier), coating compositions. Aqueous liquid, coating compositions alternatively comprise in addition to the nanoparticle system described hereinabove, about 50% to about 99.99%, alternatively from about 80% to about 99.99%, by weight of liquid carrier or suitable carrier medium, such as an alcohol and/or water.

The aqueous liquid, coating compositions of the present invention also alternatively comprise one or more adjunct materials. The term “adjunct materials”, as used herein, means any liquid, solid or gaseous material selected for aqueous liquid, coating compositions, alternatively compatible with the other ingredients present in the aqueous liquid, coating compositions of the present invention.

The specific selection of adjunct materials is readily made by considering the surface to be coated. Examples of suitable adjunct materials include, but are not limited to, surfactants, builders, bleaches, bleach activators, bleach catalysts, enzymes, enzyme stabilizing systems, chelants, optical brighteners, soil release polymers, dye transfer agents, dispersants, suds suppressors, dyes, perfumes, colorants, filler salts, hydrotropes, photoactivators, fluorescers, conditioners, hardening agents, hydrolyzable surfactants, preservatives, anti-oxidants, anti-wrinkle agents, germicides, fungicides, color speckles, silvercare, anti-tarnish and/or anti-corrosion agents, alkalinity sources, solubilizing agents, carriers, processing aids, pigments and pH control agents as described in U.S. Pat. Nos. 5,705,464; 5,710,115; 5,698,504; 5,695,679; 5,686,014 and 5,646,101. Specific adjunct materials are exemplified in detail hereinafter.

If the adjunct materials are not compatible with the other ingredients present in the aqueous liquid, coating compositions of the present invention, then suitable methods of keeping the incompatible adjunct materials and the other ingredients separate (not in contact with each other) until combination of the two components is appropriate can be used. Suitable methods can be any method known in the art, such as gelcaps, encapsulation, tablets, physical separation, etc.

The coating compositions of the present invention can comprise: (a) an effective amount of non-photoactive nanoparticles; (b) optionally a surfactant; (c) optionally having associated to said nanoparticle surface a quantity of one or more functionalized surface molecules exhibiting properties selected from the group consisting of hydrophilic, hydrophobic and mixtures thereof; (d) optionally an effective amount of photoactive nanoparticles; (e) optionally one or more adjunct ingredients; and (f) a suitable carrier medium.

The coating compositions of the present invention can also be used as detergent additive products in liquid form for automatic dishwashing machines. Such additive products are intended to supplement or boost the performance of conventional coating compositions and can be added at any stage of the dishwashing process, however, best results are achieved in the rinsing cycle.

Further, the coating compositions according to the present invention may be isotropic (clear, single phase) liquids, aqueous gels, phase-separated liquid compositions and/or colored liquid compositions.

In certain embodiments, the coating compositions are non-thixotropic. That is, the coating compositions, in such embodiments, do not have a different state when at rest (such as a gel, when they are not under shear load) than when activated (such as a liquid, when under shear load), such that the coating composition tends to return to its at rest state (e.g., a gel) after the shear load is removed. For the purposes of this description, a coating composition will not be considered to be thixotropic if it is placed in another state in other manners, such as by diluting a gel coating composition with another material to form a liquid.

The coating compositions according to the present invention may be of any suitable viscosity. The viscosity of the coating compositions should be such that they are able to be effectively applied to the surface to be coated. Thus, for instance, if the coating compositions are to be applied to a hard surface that has portions that are sloped (their slope has a vertical component), the hard surface coating composition should either be applied in a relatively low quantities that they are able to dry on the surface without running off as discussed above, or if applied in greater quantities, they should not have such a low viscosity that the coating composition runs off the surface to be coated. Non-limiting examples of suitable viscosities are less than or equal to about 1,000 Cps at 100 rpm, or any increment of 10 less than 1,000 (including, but not limited to 100 Cps, 40 Cps, and 1 Cps (the latter being the viscosity of water)). The method for determining the viscosity of the coating compositions is set forth in the Test Methods section.

The dry coating compositions of the present invention can comprise: (a) an effective amount of non-photoactive nanoparticles; (b) optionally a surfactant; (c) optionally having associated to said nanoparticle surface a quantity of one or more functionalized surface molecules exhibiting properties selected from the group consisting of hydrophilic, hydrophobic and mixtures thereof; (d) optionally one or more adjunct ingredients; and (e) an optionally, a suitable carrier medium.

The dry coating compositions of the present invention can also be used as detergent additive products in powder, granule or tablet form for automatic dishwashing machines. Such additive products are intended to supplement or boost the performance of conventional coating compositions and can be added at any stage of the dishwashing process, however, best results are achieved in the rinsing cycle.

Further, the dry coating compositions according to the present invention may be in powder, granule, tablet or encapsulated complex form.

### Suitable Carrier Medium

The carrier medium can form part of the coating composition, or it can comprise the medium in which the nanoparticles are carried (or transported) for application to the hard surface.

Several non-limiting examples of types of carrier mediums are provided by way of explanation, and not by way of limitation. In one example, the coating composition can be provided in the form of an aqueous liquid in a container, and the liquid can be sprayed onto a hard surface. In such a case, the aqueous liquid carrier in the container holding the coating composition may be referred to herein as the “static carrier”. When this coating composition is sprayed onto the hard surface, the liquid droplets in the spray may be referred to herein as the “dynamic carrier” (the medium that transports the nanoparticles to the surface in order to contact the surface). In another example, the coating composition may exist in a gel form in a container (the gel would be the form of the static carrier) and the gel could be diluted with water and sprayed as a liquid onto the hard surface (in which case the liquid spray would be the dynamic carrier). The term “carrier”, as used herein, includes both static and dynamic carriers.

Suitable carrier mediums include liquids, solids and gases. One suitable carrier medium is water, which can be distilled, deionized, or tap water. Water is valuable due to its low cost, availability, safety, and compatibility. In certain embodiments in which the carrier medium is aqueous, it may be preferred that at least some of the aqueous carrier is purified beyond the treatment it received to convert it to tap water (that is, the tap water is post-treated, e.g., deionized or distilled). The purified water could comprise: all or part of the static carrier for the composition; all or part of the dynamic carrier; or, all or part of both. Though aqueous carrier mediums are more common than dry, nonaqueous mediums, the present invention can exist as a dry powder, granule or tablet or encapsulated complex form.

Optionally, in addition to water, the carrier can contain a low molecular weight organic solvent that is highly soluble in water, e.g., ethanol, methanol, propanol, isopropanol and the like, and mixtures thereof. Low molecular weight alcohols can allow the treated hard surface to dry faster. The optional water soluble low molecular weight solvent can be used at a level of up to about 50%, typically from about 0.1% to about 25%, alternatively from about 2% to about 15%, alternatively from about 5% to about 10%, by weight of the suitable carrier medium. Factors that need to consider when a high level of solvent is combined with the suitable carrier medium are odor, flammability, dispersancy of the nanoparticle and environment impact.

In one non-limiting embodiment, the carrier can comprise any known clearcoat composition. U.S. Pat. No. 5,853,809 describes one non-limiting example of a clearcoat composition.

In other embodiments, the carrier can be an airstream. For instance, the material, or the composition can be added into a stream of moving air, and the air can convey the non-photoactive nanoparticles to the surface to be treated.

In other embodiments, the coating material or composition can simply be dropped through the air by gravity onto the surface to be treated (one example of which would be by sifting a solid material onto the surface).

### Classes of Functionalized Surface Molecules

### Polymer Classes and Examples

Polymers are optional ingredients in the compositions of the present invention. If desired, the compositions may be substantially free of polymers.

If polymers are used, in one non-limiting aspect of the invention, they can be used as part of a two-step process. In such a two-step process, the nanoparticle composition is applied to the hard surface to form a layer of nanoparticles on the hard surface. After this layer is formed and dried, a composition comprising the desired polymers can be applied to the layer of nanoparticles to further modify the nanoparticle-coated surface. Without wishing to be bound by any particular theory, when the polymer composition is applied in this way, it is believed that the nanoparticle layer anchors the polymers to the hard surface. This can be used to provide the nanoparticle coated surface with different properties than are provided by the nanoparticles alone. Using this two-step process may provide advantages over applying the polymers to the nanoparticles and then applying the polymer coated nanoparticles to the hard surface. One advantage is that the two-step process provides a more continuous covering on the surface by virtue of the uniformity of the initial layer of nanoparticles, than the less continuous structure formed by depositing nanoparticles with polymers attached thereto onto the hard surface.

Polymers and copolymers in which at least one segment or group of the polymer comprises functionality that serves to anchor or enhance adsorption on nanoparticle surfaces. These polymers also comprise at least one segment or group that serves to provide either hydrophilic or hydrophobic character to the polymer when adsorbed on a nanoparticle. Note that in some cases, the anchoring segment may also serve as the hydrophilizing segment.

Examples of the anchoring segments or groups include: polyamines, quaternized polyamines, amino groups, quaternized amino groups, and corresponding amine oxides; zwitterionic polymers; polycarboxylates; polyethers; polyhydroxylated polymers; polyphosphonates and polyphosphates; and polymeric chelants.

Examples of the hydrophilizing segments or groups include: water soluble polyethers; water soluble polyhydroxylated groups or polymers, including saccharides and polysaccharides; water soluble carboxylates and polycarboxylates; water soluble anionic groups such as carboxylates, sulfonates, sulfates, phosphates, phosphonates and polymers thereof; water soluble amines, quaternaries, amine oxides and polymers thereof; water soluble zwitterionic groups and polymers thereof; water soluble amides and polyamides; and water soluble polymers and copolymers of vinylimidazole and vinylpyrrolidone.

Examples of the hydrophobizing segments or groups include: alkyl, alkylene, and aryl groups, and polymeric aliphatic or aromatic hydrocarbons; fluorocarbons and polymers comprising fluorocarbons; silicones; hydrophobic polyethers such as poly(styrene oxide), poly(propylene oxide), poly(butene oxide), poly(tetramethylene oxide), and poly(dodecyl glycidyl ether); and hydrophobic polyesters such as polycaprolactone and poly(3-hydroxycarboxylic acids).

### Hydrophilic Surface Polymers

Ethoxylated or alkoxylated polyamines including: hexamethylenediamine, ethoxylated to a degree of 3-100 on each NH site; bis(hexamethylenetriamine), ethoxylated to a degree of 3-100 on each NH site; tetraethylenepentamine, ethoxylated to a degree of 3-100 on each NH site; polyethyleneimine of MW 300-25,000 ethoxylated to a degree of 3-00 per NH or alkoxylated with propylene or butylene oxide and ethoxylated sufficiently to confer hydrophilicity; polyvinylamine of MW 200-25,000, ethoxylated to a degree of 2-100 per NH; polyallylamine of MW 200-25,000, ethoxylated to a degree of 2-100 per NH; quaternized analogs of the above with at least one nitrogen quaternized by an alkylating agent such as methyl chloride, dimethyl sulfate, benzyl chloride, and ethylene or propylene oxide and mixtures thereof. In addition, quaternization may be with hydrophobic materials such as dodecyl bromide with the provision that the level of hydrophobic group so introduced is not sufficient to make the nanoparticle surface on which the polymer is adsorbed hydrophobic; sulfated, carboxylated, or phosphated analogs of the above with at least one of the terminal OH groups derivatized to introduce the anionic functionality; amine oxide analogs of the ethoxylated or alkoxylated polyamines in which at least one amine group is oxidized to the amine oxide; betaine and sulfobetaine analogs of the ethoxylated or alkoxylated polyamines in which at least one amine group is quaternized by an agent such as chloroacetate propanesultone, or allyl chloride which is subsequently sulfonated; and combinations of the above.

Polycarboxylated polyamines include: reaction products of polyethyleneimine with maleic acid, fumaric acid or chloroacetate. These may also comprise ethoxylated segments. See U.S. Pat. No. 5,747,440 which is incorporated by reference.

Polycarboxylates include: polyacrylic and polymethacrylic acid and copolymers with maleic acid; polymaleic acid and copolymers comprising maleic acid, fumaric acid, or maleic anhydride with another monomer such as methyl vinyl ether or a lower alkene; and graft copolymers of the above polycarboxylates which further comprise ethoxyated segments such as derived from the monomethyl ether of polyethylene glycol. The above polycarboxylate polymers may also comprise hydrophobic groups such as esters of butanol or 2-ethylhexanol, provided that their level is not sufficient to render the nanoparticle surface on which the polymer is adsorbed hydrophobic.

Polyethers include: block copolymers of ethylene oxide with propylene oxide, butylene oxide, tetramethylene oxide, styrene oxide, phenyl glycidyl ether, or fatty glycidyl ethers; block silicone copolyols comprising polydimethylsiloxane segments and polyoxyethylene segments, particularly those with small siloxane segments.

Polyhydroxyl materials include: methyl cellulose, hydroxyethyl cellulose, hydroxypropyl cellulose, carboxymethyl cellulose and hydrophobically modified analogs, provided that the level of hydrophobic substitution is not sufficient to make the nanoparticle on which the polymer is adsorbed hydrophobic; polyvinyl acetate with sufficient hydrolysis to provide hydrophilicity; and polyvinyl alcohol and hydrophobically modified polyvinyl alcohol, provided that the level of hydrophobe is not sufficient to render the nanoparticle on which the polymer is adsorbed hydrophobic.

Also included are polyphosphates and phosphonates, such as, polyphosphoric acid salts.

### Hydrophobic Surface Polymers

Alkylated polyamines include: polyethyleneimine alkylated with fatty alkylating agents such as dodecyl bromide, octadecyl bromide, oleyl chloride, dodecyl glycidyl ether and benzyl chloride or mixtures thereof; and polyethyleneimine acylated with fatty acylating agents such as methyl dodecanoate and oleyl chloride.

Silicones include: polydimethylsiloxane having pendant aminopropyl or aminoethylaminopropyl groups.

Fluorinated polymers include: polymers including as monomers (meth)acrylate esters of perfluorinated or highly fluorinated alkyl groups.

### Non-Polymeric Materials

Molecules with at least one segment or group which comprises functionality that serves to anchor or enhance adsorption on nanoparticle surfaces. These molecules also comprise at least one segment or group that serves to provide either hydrophilic or hydrophobic character to the molecule when adsorbed on a nanoparticle. Note that in some cases, the anchoring segment may also serve as the hydrophilizing segment.

Examples of the anchoring segments or groups that may also serve as the hydrophilizing segment include amino groups, quaternized amino groups, and corresponding amine oxides groups; and zwitterionic groups.

Examples of the hydrophobizing segments or groups include alkyl, aryl, alkaryl, and fluoroalkyl surfactants with cationic, zwitterionic, semi-polar, nonionic, or anionic head groups.

### Examples of Non-Polymeric Surface Modifying Materials

Fatty amines and quats including: ditallowdimethylammonium chloride; octadecyltrimethylammonium bromide; dioleyl amine; and Benzyltetradecyldimethylammonium chloride.

Examples of fluorocarbon-based surfactants include: 1-propanaminium, 3-[[(heptadecafluorooctyl)sulfonyl]amino]-N,N,N-trimethyl-, iodide (9CI)

[chemical structure]

1-propanaminium, 3-[(8-chloro-2,2,3,3,4,4,5,5,6,6,7,7,8,8-tetradecafluoro-1-oxooctyl)amino]-N,N,N-trimethyl-, methyl sulfate (9CI)

[chemical structure]

Silicone-based surfactants include: 1-propanaminium, N,N,N-trimethyl-3-[1,3,3,3-tetramethyl-1-[(trimethylsilyl)oxy]disiloxanyl]-, bromide (9CI)

[chemical structure]

Fatty zwitterionic surfactants include: 1-dodecanaminium, N-(2-hydroxy-3-sulfopropyl)-N,N-dimethyl-inner salt (9CI)

[chemical structure]

Fatty amine oxides such as hexadecyldimethylamine oxide are included. Fatty anionic surfactants including: Sodium oleyl sulfate; potassium oleate; sodium dodecylbenzenesulfonate; xodium tetradecyl sulfate; and disodium 2-hexadecenylbutanedioate.

### Surfactants

Surfactants are an optional ingredient of the present invention. Surfactants are especially useful in the coating composition as wetting agents to facilitate the dispersion of nanoparticles onto a hard surface. Surfactants are alternatively included when the coating composition is used to treat a hydrophobic hard surface or when the coating composition is applied with a spray dispenser in order to enhance the spray characteristics of the coating composition and allow the coating composition, including the nanoparticles, to distribute more evenly. The spreading of the coating composition can also allow it to dry faster, so that the treated material is ready to use sooner. For concentrated compositions, the surfactant facilitates the dispersion of many adjunct ingredients such as antimicrobial actives and perfumes in the concentrated aqueous compositions. Suitable surfactant useful in the present invention is surfactant selected from the group consisting of anionic surfactants, cationic surfactants, nonionic surfactants, amphoteric surfactants, zwitterionic surfactants and mixtures thereof.

When a surfactant is used in the coating composition of the present invention, it is added at an effective amount to provide one, or more of the benefits described herein, typically from about 0.01% to about 5%, alternatively from about 0.01% to about 3%, alternatively from about 0.01% to about 0.5%, by weight of the usage composition.

An alternative type of surfactant is ethoxylated surfactant, such as addition products of ethylene oxide with fatty alcohols, fatty acids, fatty amines, etc. Optionally, addition products of mixtures of ethylene oxide and propylene oxide with fatty alcohols, fatty acids, and fatty amines can be used. The ethoxylated surfactant includes compounds having the general formula:

R⁸-Z-(CH₂CH₂O)_{S}B

wherein R⁸ is an alkyl group or an alkyl aryl group, selected from the group consisting of primary, secondary and branched chain alkyl hydrocarbyl groups, primary, secondary and branched chain alkenyl hydrocarbyl groups, and/or primary, secondary and branched chain alkyl- and alkenyl-substituted phenolic hydrocarbyl groups having from about 6 to about 20 carbon atoms, alternatively from about 8 to about 18, alternatively from about 10 to about 15 carbon atoms; s is an integer from about 2 to about 45, alternatively from about 2 to about 20, alternatively from about 2 to about 15; B is a hydrogen, a carboxylate group, or a sulfate group; and linking group Z is —O—, —C(O)O—, or —C(O)N(R)—, and mixtures thereof, in which R, when present, is R⁸ or hydrogen.

The nonionic surfactants herein are characterized by an HLB (hydrophilic-lipophilic balance) of from 5 to 20, alternatively from 6 to 15.

Nonlimiting examples of alternative ethoxylated surfactant are:

straight-chain, primary alcohol ethoxylates, with R⁸ being C₈-C₁₈ alkyl and/or alkenyl group, alternatively C₁₀-C₁₄, and s being from about 2 to about 8;

straight-chain, secondary alcohol ethoxylates, with R being C₈-C₁₈ alkyl and/or alkenyl, e.g., 3-hexadecyl, 2-octadecyl, 4-eicosanyl, and 5-eicosanyl, and s being from about 2 to about 10;

alkyl phenol ethoxylates wherein the alkyl phenols having an alkyl or alkenyl group containing from 3 to 20 carbon atoms in a primary, secondary or branched chain configuration, alternatively from 6 to 12 carbon atoms, and s is from about 2 to about 12;

branched chain alcohol ethoxylates, wherein branched chain primary and secondary alcohols (or Guerbet alcohols), which are available, e.g., from the well-known “OXO” process or modification thereof, are ethoxylated.

Other examples of alternative ethoxylated surfactants include carboxylated alcohol ethoxylate, also known as ether carboxylate, with R⁸ having from about 12 to about 16 carbon atoms and s being from about 5 to about 13; ethoxylated quaternary ammonium surfactants, such as PEG-S cocomonium methosulfate, PEG-15 cocomonium chloride, PEG-15 oleammonium chloride and bis(polyethoxyethanol)tallow ammonium chloride.

Other suitable nonionic ethoxylated surfactants are ethoxylated alkyl amines derived from the condensation of ethylene oxide with hydrophobic alkyl amines, with R⁸ having from about 8 to about 22 carbon atoms and s being from about 3 to about 30.

Also suitable nonionic ethoxylated surfactants for use herein include alkylpolysaccharides, which are disclosed in U.S. Pat. 4,565,647, Llenado, issued Jan. 21, 1986, having a hydrophobic group containing from about 8 to about 30 carbon atoms, alternatively from about 10 to about 16 carbon atoms and a polysaccharide, e.g., a polyglycoside, hydrophilic group containing from about 1.3 to about 10, alternatively from about 1.3 to about 3. Any reducing saccharide containing 5 or 6 carbon atoms can be used, e.g., glucose, galactose and galactosyl moieties can be substituted for the glucosyl moieties. The intersaccharide bonds can be, e.g., between the one position of the additional saccharide units and the 2-, 3-, 4-, and/or 6-positions on the preceding saccharide units. The alternative alkylpolyglycosides have the formula:

R²O(CₙH₂ₙO)t(glycosyl)ₓ

wherein R² is selected from the group consisting of alkyl, alkylphenyl, hydroxyalkyl, hydroxyalkylphenyl, and mixtures thereof in which the alkyl groups contain from 10 to 18, alternatively from 12 to 14, carbon atoms; n is 2 or 3, t is from 0 to about 10; and x is from about 1.3 to about 10 alternatively. The glycosyl is alternatively derived from glucose.

Another class of alternative surfactants that are useful in the formulation of the coating compositions of the present invention, to solubilize and/or disperse silicone lubricants and/or silicone-containing adjunct shape retention copolymers, are silicone surfactants. Also known as silicone superwetting agents. They can be used alone and/or alternatively in combination with the alternative alkyl ethoxylate surfactants described herein above. Nonlimiting examples of silicone surfactants are the polyalkylene oxide polysiloxanes having a dimethyl polysiloxane hydrophobic moiety and one or more hydrophilic polyalkylene side chains, and having the general formula:

R¹—(CH₃)₂SiO—[(CH₃)₂SiO]ₐ—[(CH₃)(R¹)SiO]_{b}13 Si(CH₃)₂—R ¹

wherein a+b are from about 1 to about 50alternatively, and each R¹ is the same or different and is selected from the group consisting of methyl and a poly(ethyleneoxide/propyleneoxide) copolymer group having the general formula:

—(CH₂)ₙO(C₂H₄O)_{c}(C₃H₆O)_{d}R²

wherein n is 3 or 4; total c (for all polyalkyleneoxy side groups) has a value of from 1 to about 100, alternatively from about 6 to about 100; total d is from 0 to about 14; alternatively d is 0; total c+d has a value of from about 5 to about 150, alternatively from about 9 to about 100 and each R² is the same or different and is selected from the group consisting of hydrogen, an alkyl having 1 to 4 carbon atoms, and an acetyl group, alternatively hydrogen and methyl group. Each polyalkylene oxide polysiloxane has at least one R¹ group being a poly(ethyleneoxide/propyleneoxide) copolymer group.

Nonlimiting examples of this type of surfactants are the Silwet® surfactants, which are available OSi Specialties, Inc., Danbury, Connecticut. Representative Silwet surfactants which contain only ethyleneoxy (C₂H₄O) groups are as follows.

| Name | Average MW | Average a + b | Average total c |
|---|---|---|---|
| L-7608 | 600 | 1 | 9 |
| L-7607 | 1,000 | 2 | 17 |
| L-77 | 600 | 1 | 9 |
| L-7605 | 6,000 | 20 | 99 |
| L-7604 | 4,000 | 21 | 53 |
| L-7600 | 4,000 | 11 | 68 |
| L-7657 | 5,000 | 20 | 76 |
| L-7602 | 3,000 | 20 | 29 |
| L-7622 | 10,000 | 88 | 75 |

The molecular weight of the polyalkyleneoxy group (R¹) is less than or equal to about 10,000. Alternatively, the molecular weight of the polyalkyleneoxy group is less than or equal to about 8,000, and most alternatively ranges from about 300 to about 5,000. Thus, the values of c and d can be those numbers which provide molecular weights within these ranges. However, the number of ethyleneoxy units (—C₂H₄O) in the polyether chain (R¹) must be sufficient to render the polyalkylene oxide polysiloxane water dispersible or water soluble. If propyleneoxy groups are present in the polyalkylenoxy chain, they can be distributed randomly in the chain or exist as blocks. Surfactants which contain only propyleneoxy groups without ethyleneoxy groups are not preferred. Alternative Silwet surfactants are L-77, L-7280, L-5550, L-7280, L7608, L7607, and mixtures thereof.

Another nonlimiting example of this type of surfactant are silicone superwetting agents available from Dow Corning and sold as silicone superwetting agents such as silicone glycol copolymers (e.g. Q2-5211 and Q2-5212).

Other useful silicone surfactants are those having a hydrophobic moiety and hydrophilic ionic groups, including, e.g., anionic, cationic, and amphoteric groups. Nonlimiting examples of anionic silicone surfactants are silicone sulfosuccinates, silicone sulfates, silicone phosphates, silicone carboxylates, and mixtures thereof, as disclosed respectively in U.S. Pat. Nos, 4,717,498; 4,960,845; 5,149,765 and 5,296,434. Nonlimiting examples of cationic silicone surfactants are silicone alkyl quats (quaternary ammoniums), silicone amido quats, silicone imidazoline quats, and mixtures thereof, as disclosed respectively in U.S. Pat. Nos. 5,098,979; 5,135,294 and 5,196,499. Nonlimiting examples of amphoteric silicone surfactants are silicone betaines, silicone amino proprionates, silicone phosphobetaines, and mixtures thereof, as disclosed respectively in U.S. Pat. Nos. 4,654,161; 5,073,619 and 5,237,035. All of these patents are incorporated herein by reference.

The coating composition of the present invention to be used in the automatic dishwashing cycle can be either used along with a general detergent or actually as a rinse aid in the rinsing or drying cycle. The coating compositions according to the present invention comprise a nanoparticle system and optionally a surfactant or surfactant system wherein the surfactant can be selected from nonionic and/or anionic and/or cationic and/or ampholytic and/or zwitterionic and/or semi-polar nonionic surfactants.

The surfactant is typically present at a level of from about 0.01% to about 5% by weight. More alternative levels of incorporation are about 0.01% to about 3% by weight, most alternatively from 0.01% to 0.5% by weight of coating compositions in accord with the invention.

The surfactant is alternatively formulated to be compatible with the nanoparticle system, suitable carrier medium and optional adjunct ingredients present in the coating composition. For the hard surface coating compositions of the present invention, this may mean that the surfactants are of type that (as opposed to detersive surfactants) is low sudsing and low foaming (since it is generally undesirable for the coating to have suds or foam therein). Low foaming nonionic surfactants can be described in terms of their cloud point. Low foaming nonionic surfactants typically have a cloud point below 30° C. Non-limiting descriptions of low cloud point nonionic surfactants are contained in U.S. Pat. Nos. 6,013,613 and 6,034,044. Amphoteric and anionic surfactants can be considered to be low sudsing and low foaming if they are present below a Kraft Temperature of 30° C.

Examples of suitable nonionic, anionic, cationic, ampholytic, zwitterionic and semi-polar nonionic surfactants are disclosed in U.S. Pat. Nos. 5,707,950 and 5,576,282, incorporated herein by reference.

Other nonlimiting examples of nonionic surfactants are polyhydroxy fatty acid amide surfactants of the formula:

R²—C(O)—N(R¹)—Z,

wherein R¹ is H, or R¹ is C₁₋₄ hydrocarbyl, 2-hydroxy ethyl, 2-hydroxy propyl or a mixture thereof, R² is C₅₋₃₁ hydrocarbyl, and Z is a polyhydroxyhydrocarbyl having a linear hydrocarbyl chain with at least 3 hydroxyls directly connected to the chain, or an alkoxylated derivative thereof. Alternatively, R¹ is methyl, R² is a straight C₁₁₋₁₅ alkyl or C₁₆₋₁₈ alkyl or alkenyl chain such as coconut alkyl or mixtures thereof, and Z is derived from a reducing sugar such as glucose, fructose, maltose, lactose, in a reductive amination reaction.

Alternative anionic surfactants include alkyl alkoxylated sulfate surfactants hereof are water soluble salts or acids of the formula RO(A)ₘSO3M wherein R is an unsubstituted C₁₀-C₂₄ alkyl or hydroxyalkyl group having a C₁₀-C₂₄ alkyl component, alternatively a C₁₂-C₂₀ alkyl or hydroxyalkyl, alternatively C₁₂-C₁₈ alkyl or hydroxyalkyl, A is an ethoxy or propoxy unit, m is greater than zero, typically between about 0.5 and about 6, alternatively between about 0.5 and about 3, and M is H or a cation which can be, for example, a metal cation (e.g., sodium, potassium, lithium, calcium, magnesium, etc.), ammonium or substituted-ammonium cation. Alkyl ethoxylated sulfates as well as alkyl propoxylated sulfates are contemplated herein.

When included therein, the coating compositions of the present invention typically comprise from about 0.01% to about 5%, alternatively from about 0.01% to about 3% by weight of such anionic surfactants.

Alternative cationic surfactants are the water-soluble quaternary ammonium compounds useful in the present composition having the formula:

R₁R₂R₃R₄N⁺X⁻

wherein R₁ is C₈-C₁₆ alkyl, each of R₂, R₃ and R₄ is independently C₁-C₄ alkyl, C₁-C₄ hydroxy alkyl, benzyl, and -(C₂H₄₀)ₓH where x has a value from 2 to 5, and X is an anion. Not more than one of R₂, R₃ or R₄ should be benzyl.

When included therein, the coating compositions of the present invention typically comprise from 0.01% to about 15%, alternatively from about 0.01% to about 3% by weight of such cationic surfactants.

When included therein, the coating compositions of the present invention typically comprise from 0.01% to about 15%, alternatively from about 0.01% to about 3% by weight of such ampholytic surfactants.

When included therein, the coating compositions of the present invention typically comprise from 0.01% to about 15%, alternatively from about 0.01% to about 5% by weight of such zwitterionic surfactants.

When included therein, the coating compositions of the present invention typically comprise from 0.01% to about 15%, alternatively from about 0.01% to about 5% by weight of such semi-polar nonionic surfactants.

The detergent composition of the present invention can further comprise a cosurfactant selected from the group of primary or tertiary amines.

Suitable primary amines for use herein include amines according to the formula R₁NH₂ wherein R₁ is a C₆-C₁₂, alternatively C₆-C₁₀ alkyl chain or R4X(CH₂)ₙ, X is —O—, —C(O)N— or —NH—R₄ is a C₆-C₁₂ alkyl chain n is between 1 to 5, alternatively 3. R₁ alkyl chains can be straight or branched and can be interrupted with up to 12, alternatively less than 5 ethylene oxide moieties.

Alternative amines according to the formula herein above are n-alkyl amines. Suitable amines for use herein can be selected from 1-hexylamine, 1-octylamine, 1-decylamine and laurylamine. Other alternative primary amines include C8-C10oxypropylamine, octyloxypropylamine, 2-ethylhexyl-oxypropylamine, lauryl amido propylamine and amido propylamine.

Suitable tertiary amines for use herein include tertiary amines having the formula R₁R₂R₃N wherein R₁ and R₂ are C₁-C₈ alkyl chains or

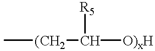

R₃ is either a C₆-C₁₂, alternatively C₆-C₁₀ alkyl chain, or R₃ is R₄X(CH₂)ₙ, whereby X is —O—, —C(O)NH—or —NH—, R₄ is a C₄-C₁₂, n is between 1 to 5, alternatively 2-3 R₅ is H or C₁-C₂ alkyl and x is between 1 to 6.

R₃ and R₄ can be linear or branched; R₃ alkyl chains can be interrupted with up to 12, alternatively less than 5, ethylene oxide moieties.

Alternative tertiary amines are R₁R₂R₃N where R₁ is a C₆-C₁₂ alkyl chain, R₂ and R₃ are C₁-C₃ alkyl or

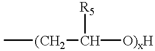

where R₅ is H or CH₃ and x=1-2.

Alternatives are the amidoamines of the formula:

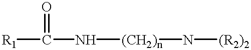

wherein R₁ is C₆-C₁₂ alkyl; n is 2-4, alternatively n is 3; R₂ and R₃ is C₁-C₄.

Alternative amines of the present invention include 1-octylamine, 1-hexylamine, 1-decylamine, 1-dodecylamine,C8-10oxypropylamine, N coco 1-3diaminopropane, coconutalkyldimethylamine, lauryldimethylamine, lauryl bis(hydroxyethyl)amine, coco bis(hydroxyethyl)amine, lauryl amine 2 moles propoxylated, octyl amine 2 moles propoxylated, lauryl amidopropyldimethylamine, C8-10 amidopropyldimethylamine and C10 amidopropyldimethylamine.

Alternative amines for use in the coating compositions herein are 1-hexylamine, 1-octylamine, 1-decylamine, 1-dodecylamine. Especially desirable are n-dodecyldimethylamine and bishydroxyethylcoconutalkylamine and oleylamine 7 times ethoxylated, lauryl amido propylamine and cocoamido propylamine.

### Alternative Adjunct Materials

### Aminocarboxylate Chelators

Chelators, e.g., ethylenediaminetetraacetic acid (EDTA), hydroxyethylenediaminetriacetic acid, diethylenetriaminepentaacetic acid, and other aminocarboxylate chelators, and mixtures thereof, and their salts, and mixtures thereof, can optionally be used to increase antimicrobial and preservative effectiveness against Gram-negative bacteria, especially Pseudomonas species. Although sensitivity to EDTA and other aminocarboxylate chelators is mainly a characteristic of Pseudomonas species, other bacterial species highly susceptible to chelators include Achromobacter, Alcaligenes, Azotobacter, Escherichia, Salmonella, Spirillum, and Vibrio. Other groups of organisms also show increased sensitivities to these chelators, including fungi and yeasts. Furthermore, aminocarboxylate chelators can help, e.g., maintaining product clarity, protecting fragrance and perfume components, and preventing rancidity and off odors.

Although these aminocarboxylate chelators may not be potent biocides in their own right, they function as potentiators for improving the performance of other antimicrobials/preservatives in the coating compositions of the present invention. Aminocarboxylate chelators can potentiate the performance of many of the cationic, anionic, and nonionic antimicrobials/preservatives, phenolic compounds, and isothiazolinones, that are used as antimicrobials/preservatives in the coating composition of the present invention. Nonlimiting examples of cationic antimicrobials/preservatives potentiated by aminocarboxylate chelators in solutions are chlorhexidine salts (including digluconate, diacetate, and dihydrochloride salts), and Quaternium-15, also known as Dowicil 200, Dowicide Q, Preventol D1, benzalkonium chloride, cetrimonium, myristalkonium chloride, cetylpyridinium chloride, lauryl pyridinium chloride, and the like. Nonlimiting examples of useful anionic antimicrobials/preservatives which are enhanced by aminocarboxylate chelators are sorbic acid and potassium sorbate. Nonlimiting examples of useful nonionic antimicrobials/preservatives which are potentiated by aminocarboxylate chelators are DMDM hydantoin, phenethyl alcohol, monolaurin, imidazolidinyl urea, and Bronopol (2-bromo-2-nitropropane-1,3-diol).

Examples of useful phenolic antimicrobials/preservatives potentiated by these chelators are chloroxylenol, phenol, tert-butyl hydroxyanisole, salicylic acid, resorcinol, and sodium o-phenyl phenate. Nonlimiting examples of isothiazolinone antimicrobials/preservatives which are enhanced by aminocarboxylate chelators are Kathon, Proxel and Promexal.

The optional chelators are present in the coating compositions of this invention at levels of, typically, from about 0.01% to about 0.3%, alternatively from about 0.02% to about 0.1% by weight of the usage compositions to provide antimicrobial efficacy in this invention.

Free, uncomplexed aminocarboxylate chelators are required to potentiate the efficacy of the antimicrobials. Thus, when excess alkaline earth (especially calcium and magnesium) and transitional metals (iron, manganese, copper, and others) are present, free chelators are not available and antimicrobial potentiation is not observed. In the case where significant water hardness or transitional metals are available or where product esthetics require a specified chelator level, higher levels may be required to allow for the availability of free, uncomplexed aminocarboxylate chelators to function as antimicrobial/preservative potentiators.

### Other Optional Ingredients

The coating composition of the present invention can optionally contain adjunct odor-controlling materials, chelating agents, antistatic agents, insect and moth repelling agents, colorants, bluing agents, antioxidants, and mixtures thereof in addition to the cyclic silicone molecules. These optional ingredients exclude the other ingredients specifically mentioned hereinbefore. Incorporating adjunct odor-controlling materials can enhance the capacity of the cyclodextrin to control odors as well as broaden the range of odor types and molecule sizes which can be controlled. Such materials include but are not limited to for example, metallic salts, zeolites, water-soluble bicarbonate salts, antimicrobial preservatives, UV absorbers, and mixtures thereof.

### Antimicrobial Preservative

Optionally, but alternatively, an antimicrobial preservative can be added to the coating composition of the present invention, alternatively solubilized, water-soluble, antimicrobial preservative, to protect the composition. Growth of microorganisms in the coating composition can lead to the problem of storage stability of hard surface coating solutions for any significant length of time. Contamination by certain microorganisms with subsequent microbial growth can result in an unsightly and/or malodorous solution. Because microbial growth in the hard surfaces is highly objectionable when it occurs, it is highly preferable to include an antimicrobial preservative, alternatively solubilized, water-soluble, antimicrobial preservative, which is effective for inhibiting and/or regulating microbial growth in order to increase storage stability of the alternatively clear, aqueous containing the hard surface coating composition.

It is preferable to use a broad spectrum preservative, e.g., one that is effective on both bacteria (both gram positive and gram negative) and fungi. A limited spectrum preservative, e.g., one that is only effective on a single group of microorganisms, e.g., fungi, can be used in combination with a broad spectrum preservative or other limited spectrum preservatives with complimentary and/or supplementary activity. A mixture of broad-spectrum preservatives can also be used. In some cases where a specific group of microbial contaminants is problematic (such as Gram negatives), aminocarboxylate chelators can be used alone or as potentiators in conjunction with other preservatives. These chelators which include, e.g., ethylenediaminetetraacetic acid (EDTA), hydroxyethylenediaminetriacetic acid, diethylenetriaminepentaacetic acid, and other aminocarboxylate chelators, and mixtures thereof, and their salts, and mixtures thereof, can increase preservative effectiveness against Gram-negative bacteria, especially Pseudomonas species.

Antimicrobial preservatives useful in the present invention include biocidal compounds, i.e., substances that kill microorganisms, or biostatic compounds, i.e., substances that inhibit and/or regulate the growth of microorganisms. Suitable preservatives are disclosed in U.S. Pat. Nos. 5,534,165; 5,578,563; 5,663,134; 5,668,097; 5,670,475; and 5,714,137, Trinh et al. issued Jul. 9, 1996; Nov. 26, 1996; Sep. 2, 1997; Sep. 16, 1997; Sep. 23, 1997; and Feb. 3, 1998 respectively, all of said patents being incorporated hereinbefore by reference. Many antimicrobial preservatives are given under the section on Antimicrobial Active given herein above. Water insoluble antimicrobial preservatives such as paraben and triclosan are useful in the coating compositions of the present invention, but they require the use of a solubilizer, an emulsifier, a dispersing agent, or the like, such as a surfactant and/or cyclodextrin to effectively distribute said preservative in the liquid composition. Alternative antimicrobial preservatives are those that are water-soluble and are effective at low levels. Water-soluble preservatives useful in the present invention are those that have a solubility in water of at least about 0.3 g per 100 ml of water, i.e., greater than about 0.3% at room temperature, alternatively greater than about 0.5% at room temperature.

The water-soluble antimicrobial preservative in the present invention is included at an effective amount. The term “effective amount” as herein defined means a level sufficient to prevent spoilage, or prevent growth of inadvertently added microorganisms, for a specific period of time. In other words, the preservative is not being used to kill microorganisms on the surface onto which the coating composition is deposited in order to eliminate odors produced by microorganisms. Instead, it is alternatively being used to prevent spoilage of the hard surface coating composition in order to increase the shelf life of the coating composition. Alternative levels of preservative are from about 0.0001% to about 0.5%, alternatively from about 0.0002% to about 0.2%, alternatively from about 0.0003% to about 0.1%, by weight of the usage composition.

The preservative can be any organic preservative material which will not cause damage to hard surface appearance, e.g., discoloration, coloration, bleaching. Alternative water-soluble preservatives include organic sulfur compounds, halogenated compounds, cyclic organic nitrogen compounds, low molecular weight aldehydes, quaternary ammonium compounds, dehydroacetic acid, phenyl and phenolic compounds, and mixtures thereof.

The preservatives of the present invention can be used in mixtures in order to control a broad range of microorganisms.

Bacteriostatic effects can sometimes be obtained for aqueous compositions by adjusting the coating composition pH to an acid pH, e.g., less than about pH 4, alternatively less than about pH 3, or a basic pH, e.g., greater than about 10, alternatively greater than about 11.

### UV Absorbers

Not to be bound by theory, but UV absorbers can operate by protecting the coating deposited on the hard surface from UV exposure. UV light is know to initiate auto-oxidation processes and UV absorbers can be deposited on hard surface in such a way that UV light is blocked from the hard surface and unsaturated fatty materials, thus preventing the initiation of auto-oxidation.

### Oxidative Stabilizers

Oxidative stabilizers can be present in the coating compositions of the present invention and these prevent yellowing by acting as a scavenger for the oxidative processes, thus preventing and/or terminating auto-oxidation, or by reversing oxidation and thus reversing yellowing. The term “oxidative stabilizer,” as used herein, includes antioxidants and reductive agents. These agents are present at a level of from 0% to about 2%, alternatively from about 0.01% to about 0.2%, alternatively from about 0.035% to about 0.1% for antioxidants, and, alternatively, from about 0.01% to about 0.2% for reductive agents.

Examples of antioxidants that can be added to the coating compositions and in the processing of this invention include a mixture of ascorbic acid, ascorbic palmitate, propyl gallate, available from Eastman Chemical Products, Inc., under the trade names Tenox® PG and Tenox® S-1; a mixture of BHT (butylated hydroxytoluene), BHA (butylated hydroxyanisole), propyl gallate, and citric acid, available from Eastman Chemical Products, Inc., under the trade name Tenox®-6; butylated hydroxytoluene, available from UOP Process Division under the trade name Sustane® BHT; tertiary butylhydroquinone, Eastman Chemical Products, Inc., as Tenox® TBHQ; natural tocopherols, Eastman Chemical Products, Inc., as Tenox® GT-1/GT-2; and butylated hydroxyanisole, Eastman Chemical Products, Inc., as BHA; long chain esters (C₈-C₂₂) of gallic acid, e.g., dodecyl gallate; Irganox® 1010; Irganox® 1035; Irganox® B 1171; Irganox® 1425; Irganox® 3114; Irganox® 3125; and mixtures thereof; alternatively Irganox® 3125, Irganox® 1425, Irganox® 3114, and mixtures thereof; alternatively Irganox® 3125 alone or mixed with citric acid and/or other chelators such as isopropyl citrate, Dequest® 2010, available from Monsanto with a chemical name of 1-hydroxyethylidene-1, 1-diphosphonic acid (etidronic acid), and Tiron®, available from Kodak with a chemical name of 4,5-dihydroxy-m-benzene-sulfonic acid/sodium salt, and DTPA®, available from Aldrich with a chemical name of diethylenetriaminepentaacetic acid.

Oxidative stabilizers can also be added at any point during the process. These assure good odor stability under long-term storage conditions.

### Colorant

Colorants, dyes, and bluing agents can be optionally added to the coating compositions for visual appeal and performance impression. When colorants are used, they are used at extremely low levels to avoid hard surface staining. Alternative colorants for use in the present compositions are highly water-soluble dyes, e.g., Liquitint® dyes available from Milliken Chemical Co. Non-limiting examples of suitable dyes are, Liquitint Blue HP®, Liquitint Blue 65®, Liquitint Pat. Blue®, Liquitint Royal Blue®, Liquitint Experimental Yellow 8949-43®, Liquitint Green HMC®, Liquitint Yellow II®, and mixtures thereof, alternatively Liquitint Blue HP®, Liquitint Blue 65®, Liquitint Pat. Blue®, Liquitint Royal Blue®, Liquitint Experimental Yellow 8949-43®, and mixtures thereof.

### Builders

The coating compositions according to the present invention can further comprise a builder or builder system, especially for coating compositions. Any conventional builder system is suitable for use herein including aluminosilicate materials, silicates, polycarboxylates, alkyl- or alkenyl-succinic acid and fatty acids, materials such as ethylenediamine tetraacetate, diethylene triamine pentamethyleneacetate, metal ion sequestrants such as aminopolyphosphonates, particularly ethylenediamine tetramethylene phosphonic acid and diethylene triamine pentamethylenephosphonic acid. Phosphate builders can also be used herein.

The present invention can include a suitable builder or detergency salt. The level of detergent salt/builder can vary widely depending upon the end use of the coating composition and its desired physical form. When present, the coating compositions will typically comprise at least about 1% builder and more typically from about 10% to about 80%, even more typically from about 15% to about 50% by weight, of the builder. Lower or higher levels, however, are not meant to be excluded.

Inorganic or P-containing detergent salts include, but are not limited to, the alkali metal, ammonium and alkanolammonium salts of polyphosphates (exemplified by the tripolyphosphates, pyrophosphates, and glassy polymeric meta-phosphates), phosphonates, phytic acid, silicates, carbonates (including bicarbonates and sesquicarbonates), sulphates, and aluminosilicates. However, non-phosphate salts are required in some locales. Importantly, the coating compositions herein function surprisingly well even in the presence of the so-called “weak” builders (as compared with phosphates) such as citrate, or in the so-called “underbuilt” situation that may occur with zeolite or layered silicate builders.

Organic detergent builders suitable for the purposes of the present invention include, but are not restricted to, a wide variety of polycarboxylate compounds. As used herein, “poly-carboxylate” refers to compounds having a plurality of carboxylate groups, alternatively at least 3 carboxylates. Polycarboxylate builder can generally be added to the coating composition in acid form, but can also be added in the form of a neutralized salt. When utilized in salt form, alkali metals, such as sodium, potassium, and lithium, or alkanolammonium salts are alternatives.

Examples of suitable silicate builders, carbonate salts, aluminosilicate builders, polycarboxylate builders, citrate builders, 3,3-dicarboxy-4-oxa-1,6-hexanedioate builders and related compounds disclosed in U.S. Pat. No. 4,566,984, to Bush, succinic acid builders, phosphorous-based builders and fatty acids, is disclosed in U.S. Pat. Nos. 5,576,282, 5,728,671 and 5,707,950.

Additional suitable builders can be an inorganic ion exchange material, commonly an inorganic hydrated aluminosilicate material, more particularly a hydrated synthetic zeolite such as hydrated zeolite A, X, B, HS or MAP.

Specific polycarboxylates suitable for the present invention are polycarboxylates containing one carboxy group include lactic acid, glycolic acid and ether derivatives thereof as disclosed in Belgian Pat. Nos. 831,368, 821,369 and 821,370. Polycarboxylates containing two carboxy groups include the water-soluble salts of succinic acid, malonic acid, (ethylenedioxy) diacetic acid, maleic acid, diglycollic acid, tartaric acid, tartronic acid and fumaric acid, as well as the ether carboxylates described in German Offenlegenschrift 2,446,686, and 2,446,687 and U.S. Pat. No. 3,935,257 and the sulfinyl carboxylates described in Belgian Pat. No. 840,623. Polycarboxylates containing three carboxy groups include, in particular, water-soluble citrates, aconitrates and citraconates as well as succinate derivatives such as the carboxymethyloxysuccinates described in British Pat. No. 1,379,241, lactoxysuccinates described in Netherlands Application 7205873, and the oxypolycarboxylate materials such as 2-oxa-1,1,3-propane tricarboxylates described in British Pat. No. 1,387,447.

Polycarboxylates containing four carboxy groups include oxydisuccinates disclosed in British Pat. No. 1,261,829, 1,1,2,2-ethane tetracarboxylates, 1,1,3,3-propane tetracarboxylates and 1,1,2,3-propane tetracarboxylates. Polycarboxylates containing sulfo substituents include the sulfosuccinate derivatives disclosed in British Pat. Nos. 1,398,421 and 1,398,422 and in U.S. Pat. No. 3,936,448, and the sulfonated pyrolysed citrates described in British Pat. No. 1,082,179, while polycarboxylates containing phosphone substituents is disclosed in British Pat. No. 1,439,000.

Alicyclic and heterocyclic polycarboxylates include cyclopentane-cis,cis,cis-tetracarboxylates, cyclopentadienide pentacarboxylates, 2,3,4,5-tetrahydro-furan - cis, cis, cis-tetracarboxylates, 2,5-tetrahydro-furan-cis-dicarboxylates, 2,2,5,5-tetrahydrofuran -tetracarboxylates, 1,2,3,4,5,6-hexane -hexacarboxylates and carboxymethyl derivatives of polyhydric alcohols such as sorbitol, mannitol and xylitol. Aromatic poly-carboxylates include mellitic acid, pyromellitic acid and the phthalic acid derivatives disclosed in British Pat. No. 1,425,343.

Of the above, the alternative polycarboxylates are hydroxycarboxylates containing up to three carboxy groups per molecule, more particularly citrates.

Builder systems for use in the present compositions include a mixture of a water-insoluble aluminosilicate builder such as zeolite A or of a layered silicate (SKS-6), and a water-insoluble carboxylate-chelating agent such as citric acid.

Builder systems include a mixture of a water-insoluble aluminosilicate builder such as zeolite A, and a water-soluble carboxylate chelating agent such as citric acid. Builder systems for use in liquid, coating compositions of the present invention are soaps and polycarboxylates.

Other suitable water-soluble organic salts are the homo- or copolymeric acids or their salts, in which the polycarboxylic acid comprises at least two carboxyl radicals separated from each other by not more than two carbon atoms. Polymers of this type are disclosed in GB-A-1,596,756. Examples of such salts are polyacrylates of MW 2000-5000 and their copolymers with maleic anhydride, such copolymers having a molecular weight of from 20,000 to 70,000, especially about 40,000.

Detergency builder salts are normally included in amounts of from 5% to 80% by weight of the coating composition alternatively from 10% to 70% and most usually from 30% to 60% by weight.

### Suds Suppressor

Another optional ingredient is a suds suppressor, exemplified by silicones, and silica-silicone mixtures. Examples of suitable suds suppressors are disclosed in U.S. Pat. Nos. 5,707,950 and 5,728,671. These suds suppressors are normally employed at levels of from 0.001% to 2% by weight of the coating composition, alternatively from 0.01% to 1% by weight.

### Enzymes

Enzymes can be included in the coating compositions for a variety of purposes, including removal of protein-based, carbohydrate-based, or triglyceride-based stains from surfaces such as dishes. Suitable enzymes include proteases, amylases, lipases, cellulases, peroxidases, and mixtures thereof of any suitable origin, such as vegetable, animal, bacterial, fungal and yeast origin. Alternative selections are influenced by factors such as pH-activity and/or stability optima, thermostability, and stability to active detergents, builders and the like. In this respect bacterial or fungal enzymes are alternatives, such as bacterial amylases and proteases, and fungal cellulases.

Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, βglucanases, arabinosidases, hyaluronidase, chondroitinase, laccase, mannanases, more preferably plant cell wall degrading enzymes and non-cell wall-degrading enzymes (WO 98/39403 A) and can, more specifically, include pectinase (WO 98/06808 A, JP10088472 A, JP10088485 A); pectolyase (WO98/06805 A1); pectin lyases free from other pectic enzymes (WO9806807 A1); chondriotinase ( EP 747,469 A); xylanase (EP 709,452 A, WO 98/39404 A, WO98/39402 A) including those derived from microtetraspora flexuosa (US 5683911); isopeptidase (WO 98/16604 A); keratinase (EP 747,470 A, WO 98/40473 A); lipase ( GB 2,297,979 A; WO 96/16153 A; WO 96/12004 A; EP 698,659 A; WO 96/16154 A); cellulase or endoglucanase (GB 2,294,269 A; WO 96/27649 A; GB 2,303,147 A; WO98/03640 A; see also neutral or alkaline cellulases derived from chrysosporium lucknowense strain VKM F-3500D as disclosed in WO9815633 A); polygalacturonase (WO 98/06809 A); mycodextranase (WO 98/13457 A); thermitase (WO 96/28558 A); cholesterol esterase (WO 98 28394 A); or any combination thereof; and known amylases; oxidoreductases; oxidases or combination systems including same (DE19523389 A1); mutant blue copper oxidases (WO9709431 A1), peroxidases (see for example U.S. Pat. No. 5,605,832, WO97/31090 A1), mannanases (WO9711164, WO 99/09126, PCT/US00/00839); xyloglucanases (WO 98/50513, PCT/US/00/00839, WO 99/02663); laccases, see WO9838287 A1 or WO9838286 A1 or for example, those laccase variants having amino acid changes in myceliophthora or scytalidium laccase(s) as described in WO9827197 A1 or mediated laccase systems as described in DE 19612193 A1), or those derived from coprinus strains (see, for example WO9810060 A1 or WO9 827198 A1), phenol oxidase or polyphenol oxidase (JP10174583 A) or mediated phenol oxidase systems (WO9711217 A); enhanced phenol oxidase systems (WO 9725468 A WO9725469 A); phenol oxidases fused to an amino acid sequence having a cellulose binding domain (WO9740127 Al, WO9740229 A1) or other phenol oxidases (WO9708325 A, WO9728257 A1) or superoxide dismutases. Oxidoreductases and/or their associated antibodies can be used, for example with H₂O₂, as taught in WO 98/07816 A. Depending on the type of composition, other redox-active enzymes can be used, even, for example, catalases (see, for example JP09316490 A).

### Other Materials

Detersive ingredients or adjuncts optionally included in the instant compositions can include one or more materials for assisting or enhancing the performance of the treating compositions, treatment of the substrate to be cleaned, or designed to improve the aesthetics of the compositions. Adjuncts which can also be included in compositions of the present invention, at their conventional art-established levels for use (generally, adjunct materials comprise, in total, from about 30% to about 99.9%, alternatively from about 70% to about 95%, by weight of the compositions), include other active ingredients such as photoactive inorganic metal oxides, color speckles, anti-tarnish agents, anti-corrosion agents, alkalinity sources, hydrotropes, anti-oxidants, organic solvents, surfactants, polymers, builders, bleaches, bleach activators, bleach catalysts, non-activated enzymes, enzyme stabilizing systems, chelants, optical brighteners, soil release polymers, wetting agents, dye transfer agents, dispersants, suds suppressors, dyes, perfumes, colorants, filler salts, photoactivators, fluorescers, conditioners, hydrolyzable cosurfactants, perservatives, anti-shrinkage agents, germicides, fungicides, silvercare, solubilizing agents, carriers, processing aids, pigments,and pH control agents as described in U.S. Pat. Nos. 5,705,464; 5,710,115; 5,698,504; 5,695,679; 5,686,014; 5,576,282; and 5,646,101, and mixtures thereof.

II. Methods of Use

The coating composition, which contains a nanoparticle system with an effective amount of non-photoactive nanoparticles in an aqueous suitable carrier medium, and optionally a surfactant, one or more charged functionalized surface molecules, an effective amount of photoactive nanoparticles, and optionally, e.g., adjunct ingredients. The coating compositions can be used by (a) mixing said nanoparticles in suitable carrier medium to form said coating composition; (b) optionally mixing said nanoparticles dispersed in suitable carrier medium with adjunct ingredients to form said coating composition; (c) optionally mixing said nanoparticles dispersed in suitable carrier medium with surfactant to form said coating composition; (d) optionally mixing said nanoparticles dispersed in suitable carrier medium with adjunct ingredients and surfactant to form said coating composition; (e) applying said coating composition to said hard surface; (f) allowing said coating composition to dry, or actively drying the coating composition, or otherwise curing the coating composition; and (g) optionally repeating any of steps (a) through (f) as needed. In some embodiments, it may be desirable for step (f) to be carried out without rinsing or agitating the coating composition during drying.

The methods of use can comprise any of the following non-limiting methods: methods of forming a substantially clear coating; methods of providing a hard surface with multiple benefits; methods of providing a surface with quick drying properties; methods of providing a surface with improved soil removal; methods of providing a self-cleaning surface; methods for providing a surface with anti-soil deposition properties and/or cleaner appearance; methods for providing a surface with enhanced gloss; methods for providing an article with enhanced color; methods for improving the smoothness of a surface; methods for reducing friction on an article; methods for minor surface defect repair; methods for forming a protective coating on a surface; methods for cleaning a surface; methods for modifying a hard surface to increase the receptivity of the surface to the subsequent application of a substance; methods for providing a surface with multi-use properties; and combinations of these and other methods.

Distribution of the coating composition can be achieved by using a spray device, an immersion container, a spray hose attachment, or an applicator, such as a fabric, a porous article such as a sponge, or roller, a pad, etc., alternatively a spray dispenser. The coating compositions and articles of the present invention which contain the nanoparticle system can be used to treat all hard surfaces to provide at least one of the following improved durable benefits: improved hard surface wetting and sheeting, quick drying, uniform drying, soil removal, self-cleaning, anti-spotting, anti-soil deposition, cleaner appearance, enhanced gloss, enhanced color, minor surface defect repair, improved smoothness, anti-hazing properties, modification of surface friction, release of actives, reduced damage to abrasion and improved transparency.

The coating compositions can reduce or eliminate the formation of water beads on treated surfaces that are contacted with water, such as wash water or rain water. In the case of glass windows, and the like, the reduction in the formation of water beads can improve visibility through the windows when they are wetted by rain water. The coating compositions can also avoid the formation of water spots left when such water beads dry, and any damage to the surface that the formation of water spots may cause due to the action of the elements (sunlight, abrasion caused by particles of dirt and the like left on the surface by these water spots, and any chemical etching caused thereby (since the nanoparticle are not chemically reactive)). The coating compositions can, in some aspects, reduce or eliminate the need to dry the surface to which it has been applied (such as the exterior surfaces of automobiles) after wetted by wash water or rain water, and the need to wax such surfaces.

In one aspect of the present invention, an effective amount of the liquid coating composition of the present invention is alternatively sprayed onto hard surfaces and/or hard surface articles include, but are not limited to: interior and exterior glass windows, walls and doors; exterior vehicle bodies, including but not limited to auto bodies, trucks, trains, boats and planes; ceramic tile, floors and walls; bathroom and kitchen countertops; appliances; metal fixtures, siding and roofing; dishware; wood furniture, flooring and wall treatments; stone tiles and walls; asphalt roofing, siding and driveways; jewelry; exterior building surfaces; painted and coated surfaces, etc. When the coating composition is sprayed onto a hard surface, an effective amount of the nanoparticle system should be deposited onto the hard surface, with the hard surface becoming damp or totally saturated with the coating composition. The hard surface coating composition can also be applied to a hard surface via roll coating, curtain coating, a dipping and/or soaking process in an immersion container. Any of the application steps can be followed by a drying, or curing step.

In one non-limiting aspect of the present invention, the coating composition is used to apply a durable coating on the surface of a vehicle, such as an automobile. The steps in applying the coating composition can involve one or more of the following steps, in addition to a step of applying the coating composition: a pre-wash step; a washing step, such as with soap and a sponge to produce lather; a rinse step; an activated rinse step; a step for applying the coating composition described herein; and a drying step. These steps can be performed by consumers at home, such as if they are provided with the components needed to carry out the steps in the form of a kit, such as a car care kit. Instructions can be provided. Alternatively, the steps can be performed in a commercial operation, such as at a car wash, which may be of the automatic type, or the “self serve” type where customers use a wash bay to spray their car clean.

The hard surface coating composition can be applied to the hard surface at any suitable air temperature. It has been found that the hard surface coating composition can be applied at any temperature above freezing. For instance, the coating composition can be applied at temperatures as low as 1°, 5°, 10°, or 15° C.

The hard surface can then be subjected to conditions so as to cure or dry the coating composition. The drying step can comprise air drying in ambient conditions. Alternatively, the drying step can comprise actively drying or curing the coating composition by utilizing any technology known for accelerating a drying or curing process. The term “actively curing”, as used herein, refers to any technique used to accelerate the curing process beyond merely allowing the coating composition to dry under ambient conditions. For instance, known cross-linking agents can be incorporated into the composition to cure the same. Although various methods of curing may be used, thermal or heat curing, or heat drying is preferred. The hard surface coating composition can be heat dried at any air temperature which is above the ambient temperature (which air temperature of drying may, for example, be greater than or equal to about any five degree increment above 0° C.). Generally, heat curing is effected by exposing the coated surface to elevated temperatures, such as those provided by radiative heat sources. Such technology may include moving (or forced) air drying such as drying by fans, blow drying, etc., or the application of heat (such as by radiative heat sources, such as drying in ovens, etc.), or both moving or forced air drying and the application of heat (such as heated blow drying).

It has been found that heat drying the hard surface coating composition can greatly increase the durability of the hard surface coating. The amount of increase in the durability of the hard surface coating composition can, in fact, be quite unexpectedly high.

For instance, in some embodiments, it has been found that when the hard surface coating composition is applied to a hard surface and air dried at ambient temperature, the hard surface coating is able to provide the benefits described herein (or at least some of such benefits) after it has been subjected to one or two routines/cycles of the mechanical Scrub method described in the Test Methods section below. This is believed to translate into about two to four weeks of surface protection and modification in an outside environment, including washing the surface about once a week.

However, if the hard surface coating composition is heat dried above ambient temperature (which may be about 20-22° C. in the case of a moderate outside temperature, or interior air temperature in a building), the hard surface coating formed on the surface has been found to have increased durability, so that it provides more lasting benefits. The term “long lasting”, as used herein, refers to a coating that is able to provide at least some of the benefits described herein after more than one cycle of the Scrub Method described in the Test Methods section. The hard surface coating composition can be heat dried at any air temperature of greater than or equal to about 50° C. and any five degree increment above 50° C. (e.g., 80° C.) to provide long lasting benefits. However, this could be influenced by accelerants, i.e., solvents and cross-linking agents. The hard surface coating composition can be air dried at temperatures that approach, but preferably do not exceed a temperature that would cause the hard surface being coated to be altered, such as by melting, buckling, or the like. In one non-limiting embodiment, the hard surface coating composition can be applied to an automobile body panel, and then heat dried at an air temperature of about 145° C. to about 160° C., or any five degree increment therebetween. It has been found that a coating dried with such a heat drying process can withstand 500 or more cycles of the mechanical scrubbing test. In another non-limiting embodiment, the hard surface coating composition can be applied to an automobile body panel, and then heat dried at an air temperature of about 135° C. It has been found that a coating dried with such a heat drying process can withstand 50 or more cycles of the mechanical scrubbing test.

In another non-limiting embodiment, the hard surface coating composition can be applied to automobile glass, and then heat dried at an air temperature of about 135° C. It has been found that a coating dried with such a heat drying process can withstand 50 or more cycles of the mechanical scrubbing test.

The dried hard surface coating is preferably substantially hydrophilic. The dried hard surface, in some embodiments may have a contact angle with water of: less than or equal to about 60; or alternatively, less than or equal to about any increment of five less than 60 (e.g., less than or equal to about 50, 45, 40, . . . , 20, . . . , 10, etc.). In some embodiments, higher temperatures of application or drying result in higher initial contact angles, and lower temperatures of application or drying result in lower initial contact angles. However, the contact angle can change over the duration of the coating. The visual appearance of the dried hard surface coating, in some embodiments, can be improved after the surface is hydrated for 500 seconds. The visual improvement is characterized as improved sheeting or improved curtaining of water on the surface coating.

The application of the hard surface coating composition can be performed by large-scale processes on hard surfaces and/or finished articles in an industrial application, or in the consumer's home by the use of an article of manufacture.

In one aspect, the method of the present invention can be used in an automobile manufacturing and/or painting operation to provide a durable finish on the exterior of an automobile. FIG. 4 is a flow chart which shows one non-limiting example of the steps in painting and applying a clear coat finish to the exterior body panels of an automobile. One clear coat composition comprises a polyurethane produced from polymerization of carbamate and melamin composition, such as that available under the tradename URECLEAR® from BASF,

### Southfield, Mich., USA.

In the example shown in FIG. 4, the first step in painting the automobile body panels is the application of two coats of primer without flash time (elapsed time for organic solvent evaporation) between coats. Following this, the primer is flashed (dried at lower temperatures at first to drive off much of the solvent(s), then heated to a higher temperature to cure the same; this prevents bubbling) for 10 minutes. The panels are then baked at 129° C. for 30 minutes. After this, two coats of basecoat (paint) are applied with a 60 second flash in between coats. Then, two coats of clear coat are applied with a 60 second flash in between coats. The panels are then heated for 10 minutes at 82° C. This heating process is ramped up to 132° C., and held at that temperature for 25 minutes. The final step is to place the panels in an oven at 160° C. for five minutes. Of course, in other processes the temperatures and times can be varied in any suitable manner. For example, a process used by ACT Laboratories, Inc. (Hillsdale, Mich., USA) that is used in the automotive industry to test automobile body panels is described in the Test Methods section.

As shown in FIG. 4, the hard surface coating composition described herein can be applied at many different steps in the process of applying the clear coat finish to the automobile body panels. The hard surface coating composition described herein can be applied after said one or more coats of paint are applied to said automobile body parts; during the step of applying one or more coats of clear coat to said automobile body parts; or, after said one or more coats of clear coat are applied to said automobile body parts.

In other embodiments, it may be desired to use nanoparticles in the form of a powder. The nanoparticles can be used alone, or they can be combined with some other substance to form a composition. The clear coat composition, in such embodiments can be provided in any suitable form, including, but not limited to liquids, and powders. In embodiments in which it is desired to use a powder hard surface coating comprising nanoclay with a powder clear coat, it may be desirable to modify the application procedure. The application procedure can be modified in many different ways. In any embodiments desired, the surface onto which the powder coating is to be deposited can also be charged to facilitate attraction and adherence of the nanoparticles thereto.

For instance, the clear coat powder composition can first be applied by electrostatic deposition techniques or fluidized bed techniques or other such techniques that are commonly practiced, followed by application of the nanoclay coating composition by electrostatic deposition or fluidized bed or other such techniques that are commonly practiced. The surface can then be heated to provide adequate curing.

In another embodiment, the clear coat powder composition can first be coated with the powdered hard surface coating comprising nanoclay. This can be followed by application of the clear coat powder composition coated with the powder hard surface coating comprising nanoclay to the desired surface by electrostatic deposition techniques or fluidized bed techniques or other such techniques that are commonly practiced. The surface can then be heated to provide adequate curing.

In another embodiments, the clear coat powder composition and the powder hard surface coating comprising nanoclay can be applied simultaneously to the desired surface by electrostatic deposition techniques or fluidized bed techniques or other such techniques that are commonly practiced. The surface can then be heated to provide adequate curing.

In other embodiments, such as in the auto body repair business, where in some cases it is not possible to heat the body panels to the temperatures described in the preceding paragraphs without damaging other portions of the automobile, the hard surface coating composition can be applied at much lower temperatures, such as temperatures above 60° C. (the temperature the surface of a car can reach on a hot day). In such embodiments, accelerants can be used, if desired.

In embodiments in which it is desired to use an aqueous hard surface coating composition comprising nanoclay with an organic clearcoat, it may be desirable to modify the application procedure. For instance, the clearcoat composition could first be applied, and then a “skim” or film could be formed on the top of the wet clear coat using techniques known to those of skill in the art (clearcoat compositions generally dry from the top portion thereof to the bottom, and become slightly tacky when drying). The hard surface coating composition could be placed on top of the skim, and then the clearcoat with the hard surface coating composition thereon could be heated together.

In any of the embodiments described in this specification, multiple layers of the hard surface coating composition can be applied to any of the hard surfaces described herein. These multiple layers of hard surface coating composition can all have the same chemical composition, or they can have different chemical compositions.

In addition to applying the hard surface coating composition described herein to automotive body panels, the hard surface coating composition can be applied to glass, plastic, or rubber. The hard surface coating composition can, for example, be applied to automotive window glass. The hard surface coating composition can be applied to automotive window glass at any stage in the manufacture of the window glass, or in the manufacture of the automobile.

In other embodiments, the method of applying the hard surface coating composition described herein can be applied to the components of aircraft, water craft, buildings, etc. to provide a more durable surface coating.

The present invention also comprises a method of using concentrated liquid or solid coating compositions, which are diluted to form compositions with the usage concentrations, as given hereinabove, for use in the “usage conditions”. Concentrated compositions comprise a higher level of nanoparticle concentration, typically from about 0.1% to about 50%, alternatively from about 0.5% to about 40%, alternatively from about 1% to about 30%, by weight of the concentrated coating composition.

Concentrated compositions are used in order to provide a less expensive product. The concentrated product is alternatively diluted with 1,000 parts suitable carrier medium, alternatively 100 parts suitable carrier medium, and alternatively 10 parts suitable carrier medium of the coating composition.

In another embodiment of the present invention there is a provided a method of using a liquid, coating composition comprising (a) an effective amount of non-photoactive nanoparticles; (b) optionally a surfactant; (c) optionally having associated to said nanoparticle surface a quantity of one or more functionalized surface molecules exhibiting properties selected from the group consisting of hydrophilic, hydrophobic and mixtures thereof; (d) optionally an effective amount of photoactive nanoparticles; (e) optionally one or more adjunct ingredients; and (f) a suitable carrier medium, alternatively concentrated liquid, for treating dishware in the rinse step of an automatic dishwashing machine. The rinse water should contain typically from about 0.0005% to about 1%, alternatively from about 0.0008% to about 0.1%, alternatively from about 0.001% to about 0.02% of the nanoparticle.

Another alternative method comprises the treatment of dishware with a coating composition dispensed from a sprayer at the beginning and/or during the drying cycle. It is preferable that the treatment is performed in accordance with the instructions for use, to ensure that the consumer knows what benefits can be achieved, and how best to obtain these benefits.

Another alternative method comprises stripping at least one layer of nanoparticles from the transparent coating on a treated hard surface using mechanical or chemical means to remove the layer of foreign matter (i.e. soil, spotting residues, food etc.) in accordance with the instructions for use to impart the benefits desired, wherein mechanical or chemical means does not exclude the weathering or optionally the normal use of the surface. Not to be limited by theory, the strippable-film mechanism of this method is depicted in FIGS. 1-3.

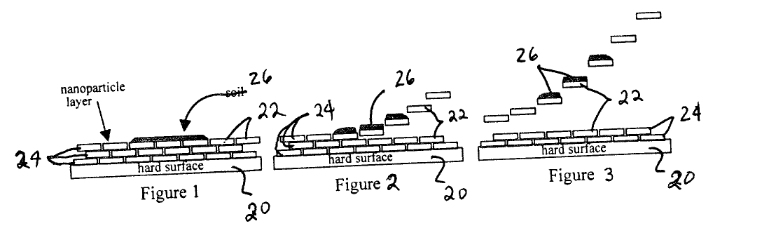

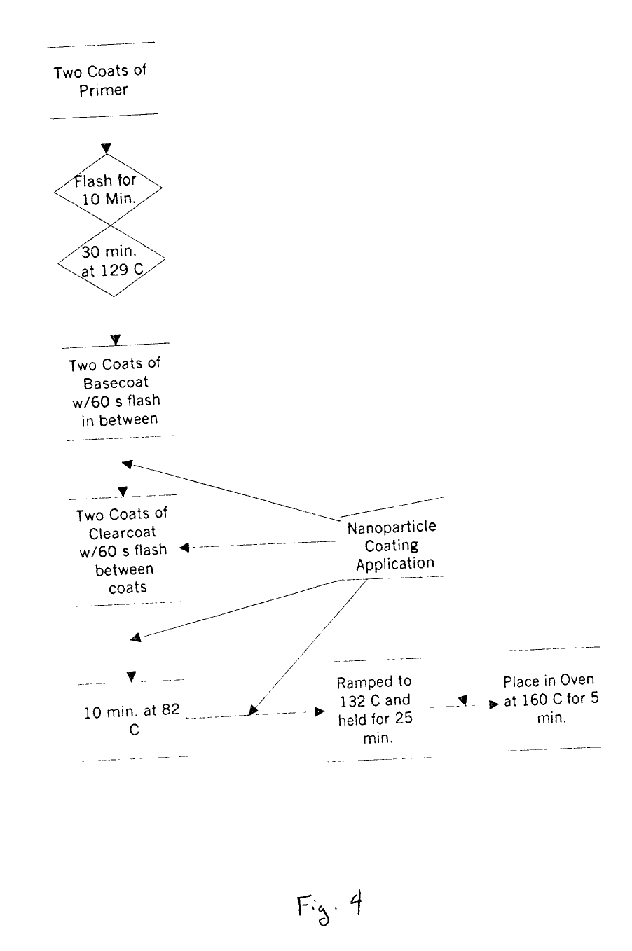

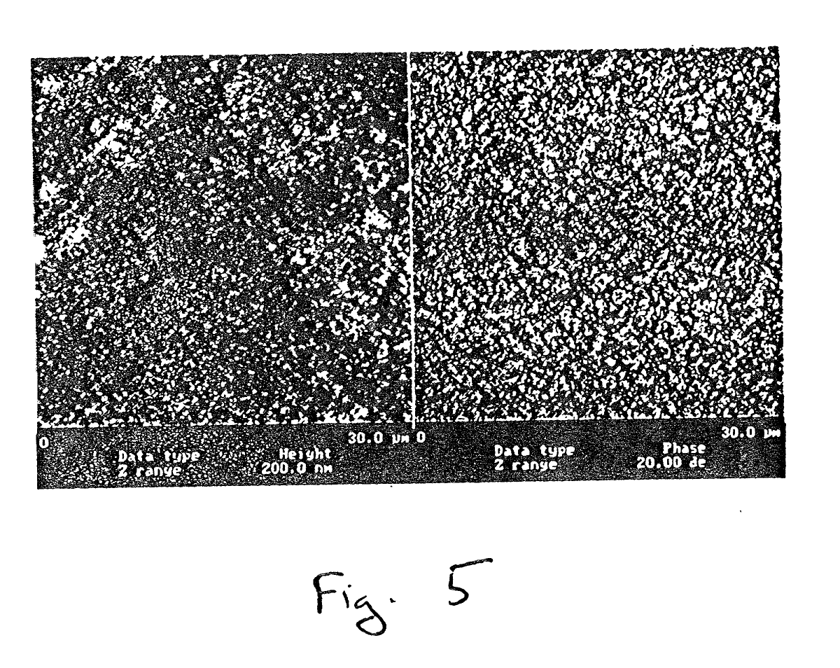

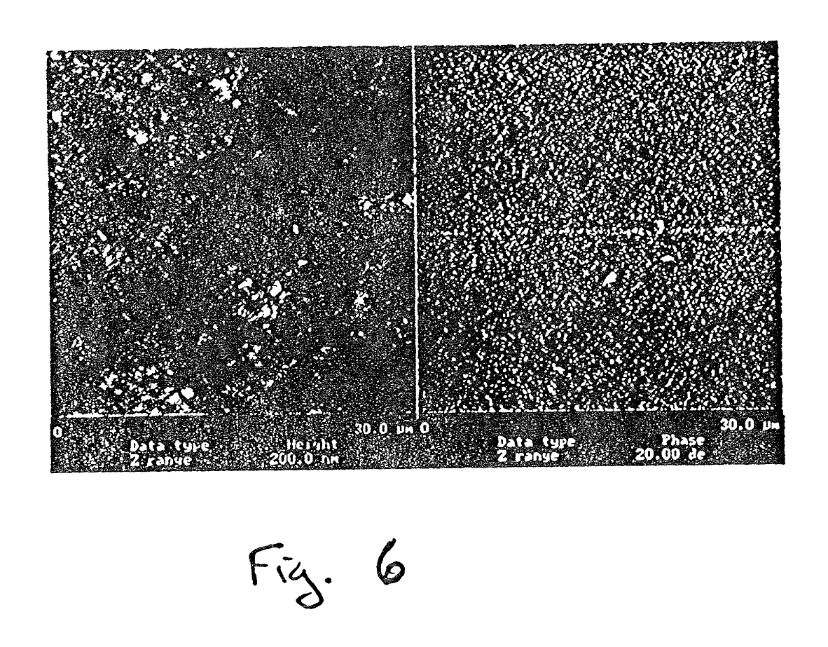

In FIGS. 1-3, the hard surface is designated by reference number 20. The individual nanoparticles are designated by reference number 26, and the layers formed thereby are designated by reference number 24. The soil deposited on the nanoparticles is designated by reference number 26. In one embodiment of the present invention, such as an automotive, exterior building or dishware surface application, an effective nanoparticle coating is deposited as an invisible film, preventing soil 26 from adhering to the hard surface 20 (FIG. 1). The nanoparticle coating consists of multiple effective layers 24 of nanoparticle sheets that provide the benefit. During the weathering, washing or stripping treatment process, at least one top layer 24 of the nanoparticle coating is removed, taking the soil 26 along with it (FIGS. 2 and 3).

III. Articles of Manufacture

The present invention also relates to an article of manufacture comprising the hard surface coating composition in a package, in association with instructions for how to use the coating composition to treat hard surfaces correctly, in order to obtain the desirable results, viz, improved multi-use benefits consisting of improved hard surface wetting and sheeting, quick drying, uniform drying, soil removal, self-cleaning, anti-spotting, anti-soil deposition, cleaner appearance, enhanced gloss, enhanced color, minor surface defect repair, improved smoothness, anti-hazing properties, modification of surface friction, release of actives, reduced damage to abrasion, improved transparency and mixtures thereof. An alternative article of manufacture comprises said composition in a spray dispenser, in association with instructions for how to use the coating composition to treat hard surfaces correctly, including, e.g., the manner and/or amount of composition to spray, and the alternative ways of applying the coating composition, as will be described with more detailed herein below. It is important that the instructions be as simple and clear as possible, so that using pictures and/or icons is desirable.

### Spray Dispenser

An article of manufacture herein comprises a spray dispenser. The coating composition is placed into a spray dispenser in order to be distributed onto the hard surface. Said spray dispenser for producing a spray of liquid droplets can be any of the manually activated means as is known in the art, e.g. trigger-type, pump-type, non-aerosol self-pressurized, and aerosol-type spray means, for treating the coating composition to small hard surface areas and/or a small number of substrates, as well as non-manually operated, powered sprayers for conveniently treating the coating composition to large hard surface areas and/or a large number of substrates. The spray dispenser herein does not normally include those that will substantially form the clear, aqueous coating composition. It has been found that providing smaller particle droplets increases the performance. Desirably, the Sauter mean particle diameter is from about 10 μm to about 120 μm, alternatively, from about 20 μm to about 100 μm. Coating benefits for example are improved by providing small particles (droplets), especially when the surfactant is present.

The spray dispenser can be an aerosol dispenser. Said aerosol dispenser comprises a container which can be constructed of any of the conventional materials employed in fabricating aerosol containers. The dispenser must be capable of withstanding internal pressure in the range of from about 20 to about 110 p.s.i.g., alternatively from about 20 to about 70 p.s.i.g. The one important requirement concerning the dispenser is that it be provided with a valve member which will permit the clear, aqueous coating composition contained in the dispenser to be dispensed in the form of a spray of very fine, or finely divided, particles or droplets. The aerosol dispenser utilizes a pressurized sealed container from which the clear, aqueous coating composition is dispensed through a special actuator/valve assembly under pressure. Incorporating therein a gaseous component generally known as a propellant pressurizes the aerosol dispenser. Common aerosol propellants, e.g., gaseous hydrocarbons such as isobutane, and mixed halogenated hydrocarbons, can be used. Halogenated hydrocarbon propellants such as chlorofluoro hydrocarbons have been alleged to contribute to problems, and are not alternatives. When cyclodextrin is present hydrocarbon propellants are not alternatives, because they can form complexes with the cyclodextrin molecules thereby reducing the availability of uncomplexed cyclodextrin molecules for odor absorption. Alternative propellants are compressed air, nitrogen, inert gases, carbon dioxide, etc. A more complete description of commercially available aerosol-spray dispensers appears in U.S. Pat. Nos.: 3,436,772, Stebbins, issued Apr. 8, 1969; and 3,600,325, Kaufman et al., issued Aug. 17, 1971; both of said references are incorporated herein by reference.

Alternatively the spray dispenser can be a self-pressurized non-aerosol container having a convoluted liner and an elastomeric sleeve. Said self-pressurized dispenser comprises a liner/sleeve assembly containing a thin, flexible radially expandable convoluted plastic liner of from about 0.010 to about 0.020 inch thick, inside an essentially cylindrical elastomeric sleeve. The liner/sleeve is capable of holding a substantial quantity of coating composition and of causing said composition to be dispensed. A more complete description of self-pressurized spray dispensers can be found in U.S. Pat. Nos. 5,111,971, Winer, issued May 12, 1992, and 5,232,126, Winer, issued Aug. 3, 1993; both of said references are herein incorporated by reference. Another type of aerosol spray dispenser is one wherein a barrier separates the coating composition from the propellant (alternatively compressed air or nitrogen), as disclosed in U.S. Pat. No. 4,260,110, issued Apr. 7, 1981, and incorporated herein by reference. Such a dispenser is available from EP Spray Systems, East Hanover, N.J.

Alternatively, the spray dispenser is a non-aerosol, manually activated, pump-spray dispenser. Said pump-spray dispenser comprises a container and a pump mechanism which securely screws or snaps onto the container. The container comprises a vessel for containing the aqueous coating composition to be dispensed.

The pump mechanism comprises a pump chamber of substantially fixed volume, having an opening at the inner end thereof. Within the pump chamber is located a pump stem having a piston on the end thereof disposed for reciprocal motion in the pump chamber. The pump stem has a passageway there through with a dispensing outlet at the outer end of the passageway and an axial inlet port located inwardly thereof.

The container and the pump mechanism can be constructed of any conventional material employed in fabricating pump-spray dispensers, including, but not limited to: polyethylene; polypropylene; polyethyleneterephthalate; blends of polyethylene, vinyl acetate, and rubber elastomer. An alternative container is made of clear, e.g., polyethylene terephthalate. Other materials can include stainless steel. A more complete disclosure of commercially available dispensing devices appears in: U.S. Pat. Nos.: 4,895,279, Schultz, issued Jan. 23, 1990; 4,735,347, Schultz et al., issued Apr. 5, 1988; and 4,274,560, Carter, issued Jun. 23, 1981; all of said references are herein incorporated by reference.

Alternatively, the spray dispenser is a manually activated trigger-spray dispenser. Said trigger-spray dispenser comprises a container and a trigger both of which can be constructed of any of the conventional material employed in fabricating trigger-spray dispensers, including, but not limited to: polyethylene; polypropylene; polyacetal; polycarbonate; polyethyleneterephthalate; polyvinyl chloride; polystyrene; blends of polyethylene, vinyl acetate, and rubber elastomer. Other materials can include stainless steel and glass. An alternative container is made of clear, e.g. polyethylene terephthalate. The trigger-spray dispenser does not incorporate a propellant gas into the odor-absorbing composition, and alternatively it does not include those that will form the coating composition. The trigger-spray dispenser herein is typically one which acts upon a discrete amount of the coating composition itself, typically by means of a piston or a collapsing bellows that displaces the coating composition through a nozzle to create a spray of thin liquid. Said trigger-spray dispenser typically comprises a pump chamber having either a piston or bellows which is movable through a limited stroke response to the trigger for varying the volume of said pump chamber. This pump chamber or bellows chamber collects and holds the product for dispensing. The trigger spray dispenser typically has an outlet check valve for blocking communication and flow of fluid through the nozzle and is responsive to the pressure inside the chamber. For the piston type trigger sprayers, as the trigger is compressed, it acts on the fluid in the chamber and the spring, increasing the pressure on the fluid. For the bellows spray dispenser, as the bellows is compressed, the pressure increases on the fluid. The increase in fluid pressure in either type of trigger spray dispenser acts to open the top outlet check valve. The top valve allows the product to be forced through the swirl chamber and out the nozzle to form a discharge pattern. An adjustable nozzle cap can be used to vary the pattern of the fluid dispensed.

For the piston spray dispenser, as the trigger is released, the spring acts on the piston to return it to its original position. For the bellows spray dispenser, the bellows acts as the spring to return to its original position. This action causes a vacuum in the chamber. The responding fluid acts to close the outlet valve while opening the inlet valve drawing product up to the chamber from the reservoir.

A more complete disclosure of commercially available dispensing devices appears in U.S. Pat. Nos. 4,082,223, Nozawa, issued Apr. 4, 1978; 4,161, 288, McKinney, issued Jul. 17, 1985; 4,434,917, Saito et al., issued Mar. 6, 1984; and 4,819,835, Tasaki, issued Apr. 11, 1989; 5,303,867, Peterson, issued Apr. 19, 1994; all of said references are incorporated herein by reference.

A broad array of trigger sprayers or finger pump sprayers is suitable for use with the coating compositions of this invention. These are readily available from suppliers such as Calmar, Inc., City of Industry, Calif.; CSI (Continental Sprayers, Inc.), St. Peters, Mo.; Berry Plastics Corp., Evansville, Ind., a distributor of Guala® sprayers; or Seaquest Dispensing, Cary, Ill.

Nonlimiting examples of trigger sprayers are the blue inserted Guala sprayer, available from Berry Plastics Corp., or the Calmar TS800-1A®, TS1300®, and TS-800-2®, available from Calmar Inc., because of the fine uniform spray characteristics, spray volume, and pattern size. Alternatives include sprayers with precompression features and finer spray characteristics and even distribution, such as Yoshino sprayers from Japan. Any suitable bottle or container can be used with the trigger sprayer, an alternative bottle is a 17 fl-oz. bottle (about 500 ml) of good ergonomics similar in shape to the Cinch® bottle. It can be made of any materials such as high-density polyethylene, polypropylene, polyvinyl chloride, polystyrene, polyethylene terephthalate, glass, or any other material that forms bottles. Alternatively, it is made of high-density polyethylene or clear polyethylene terephthalate.

For smaller fluid ounce sizes ( such as 1 to 8 ounces), a finger pump can be used with canister or cylindrical bottle. The alternative pump for this application is the cylindrical Euromist II® from Seaquest Dispensing.

The article of manufacture herein can also comprise a non-manually operated spray dispenser. By “non-manually operated” it is meant that the spray dispenser can be manually activated, but the force required to dispense the coating composition is provided by another, non-manual means. Non-manually operated sprayers include, but are not limited to, powered sprayers, air aspirated sprayers, liquid aspirated sprayers, electrostatic sprayers, and nebulizer sprayers. The coating composition is placed into a spray dispenser in order to be distributed onto the hard surface.

Powered sprayers include self-contained powered pumps that pressurize the aqueous coating composition and dispense it through a nozzle to produce a spray of liquid droplets. Powered sprayers are attached directly or remotely through the use of piping/tubing to a reservoir (such as a bottle) to hold the aqueous coating composition. Powered sprayers can include, but are not limited to, centrifugal or positive displacement designs. It is preferred that the powered sprayer be powered by a portable DC electrical current from either disposable batteries (such as commercially available alkaline batteries) or rechargeable battery units (such as commercially available nickel cadmium battery units). Powered sprayers can also be powered by standard AC power supply available in most buildings. The discharge nozzle design can be varied to create specific spray characteristics (such as spray diameter and particle size). It is also possible to have multiple spray nozzles for different spray characteristics. The nozzle may or may not contain an adjustable nozzle shroud that would allow the spray characteristics to be altered.

Nonlimiting examples of commercially available powered sprayers are disclosed in U.S. Pat. No. 4,865,255, Luvisotto, issued Sep. 12, 1989 which is incorporated herein by reference. Alternative powered sprayers are readily available from suppliers such as Solo, Newport News, Va. (e.g., Solo Spraystar™ rechargeable sprayer, listed as manual part #: US 460 395) and Multi-sprayer Systems, Minneapolis, Minn. (e.g., model: Spray 1).

Air aspirated sprayers include the classification of sprayers generically known as “air brushes”. A stream of pressurized air draws up the aqueous coating composition and dispenses it through a nozzle to create a spray of liquid. The coating composition can be supplied via separate piping/tubing or more commonly is contained in ajar to which the aspirating sprayer is attached.

Nonlimiting examples of commercially available air aspirated sprayers appears in U.S. Pat. No. 1,536,352, Murray, issued Apr. 22, 1924 and 4,221,339, Yoshikawa, issues Sep. 9, 1980; all of said references are incorporated herein by reference. Air aspirated sprayers are readily available from suppliers such as The Badger Air-Brush Co., Franklin Park, Ill. (e.g., model #: 155) and Wilton Air Brush Equipment, Woodridge, Ill. (e.g., stock #: 415-4000, 415-4001, 415-4100).

Liquid aspirated sprayers are typical of the variety in widespread use to spray garden chemicals. The aqueous coating composition is drawn into a fluid stream by means of suction created by a Venturi effect. The high turbulence serves to mix the aqueous coating composition with the fluid stream (typically water) in order to provide a uniform mixture/concentration. It is possible with this method of delivery to dispense the aqueous concentrated coating composition of the present invention and then dilute it to a selected concentration with the delivery stream.

Liquid aspirated sprayers are readily available from suppliers such as Chapin Manufacturing Works, Batavia, N.Y. (e.g., model #: 6006).

Electrostatic sprayers impart energy to the aqueous coating composition via a high electrical potential. This energy serves to atomize and charge the aqueous coating composition, creating a spray of fine, charged particles. As the charged particles are carried away from the sprayer, their common charge causes them to repel one another. This has two effects before the spray reaches the target. First, it expands the total spray mist. This is especially important when spraying to fairly distant, large areas. The second effect is maintenance of original particle size. Because the particles repel one another, they resist collecting together into large, heavier particles like uncharged particles do. This lessens gravity's influence, and increases the charged particle reaching the target. As the mass of negatively charged particles approach the target, they push electrons inside the target inwardly, leaving all the exposed surfaces of the target with a temporary positive charge. The resulting attraction between the particles and the target overrides the influences of gravity and inertia. As each particle deposits on the target, that spot on the target becomes neutralized and no longer attractive. Therefore, the next free particle is attracted to the spot immediately adjacent and the sequence continues until the entire surface of the target is covered. Hence, charged particles improve distribution and reduce drippage.

Nonlimiting examples of commercially available electrostatic sprayers appears in U.S. Pat. No. 5,222,664, Noakes, issued Jun. 29, 1993; U.S. Pat. No. 4,962,885, Coffee, issued Oct. 16, 1990; U.S. Pat. No. 2,695,002, Miller, issued Nov. 1954; U.S. Pat. No. 5,405,090, Greene, issued Apr. 11, 1995; U.S. Pat. No. 4,752,034, Kuhn, issued Jun. 21, 1988; U.S. Pat. No. 2,989,241, Badger, issued Jun. 1961; all of said patents are incorporated herein by reference. Electrostatic sprayers are readily available from suppliers such as Tae In Tech Co, South Korea and Spectrum, Houston, Tex.

Nebulizer sprayers impart energy to the aqueous coating composition via ultrasonic energy supplied via a transducer. This energy results in the aqueous coating composition to be atomized. Various types of nebulizers include, but are not limited to, heated, ultrasonic, gas, venturi, and refillable nebulizers.

Nonlimiting examples of commercially available nebulizer sprayers appears in U.S. Pat. No. 3,901,443, Mitsui, issued Aug. 26, 1975; U.S. Pat. No. 2,847,248, Schmitt, issued Aug. 1958; U.S. Pat. No. 5,511,726, Greenspan, issued Apr. 30, 1996; all of said patents are incorporated herein by reference. Nebulizer sprayers are readily available from suppliers such as A&D Engineering, Inc., Milpitas, Calif. (e.g., model A&D Un-231 ultrasonic handy nebulizer) and Amici, Inc., Spring City, Pa. (model: swirler nebulizer).

The alternative article of manufacture herein comprises a non-manually operated sprayer, such as a battery-powered sprayer, containing the aqueous coating composition. Alternatively the article of manufacture comprises a combination of a non-manually operated sprayer and a separate container of the aqueous coating composition, to be added to the sprayer before use and/or to be separated for filling/refilling. The separate container can contain a usage composition, or a concentrated composition to be diluted before use, and/or to be used with a diluting sprayer, such as with a liquid aspirated sprayer, as described herein above.

Also, as described hereinbefore, the separate container should have structure that mates with the rest of the sprayer to ensure a solid fit without leakage, even after motion, impact, etc. and when handled by inexperienced consumers. The sprayer desirably can also have an attachment system that is safe and alternatively designed to allow for the liquid container to be replaced by another container that is filled. For example, a filled container can replace the fluid reservoir. This can minimize problems with filling, including minimizing leakage, if the proper mating and sealing means are present on both the sprayer and the container. Desirably, the sprayer can contain a shroud to ensure proper alignment and/or to permit the use of thinner walls on the replacement container. This minimizes the amount of material to be recycled and/or discarded. The package sealing or mating system can be a threaded closure (sprayer) which replaces the existing closure on the filled and threaded container. A gasket is desirably added to provide additional seal security and minimize leakage. The gasket can be broken by action of the sprayer closure. These threaded sealing systems can be based on industry standards. However, it is highly desirable to use a threaded sealing system that has non-standard dimensions to ensure that the proper sprayer/bottle combination is always used. This helps prevent the use of fluids that are toxic, which could then be dispensed when the sprayer is used for its intended purpose.

An alternative sealing system can be based on one or more interlocking lugs and channels. Such systems are commonly referred to as “bayonet” systems. Such systems can be made in a variety of configurations, thus better ensuring that the proper replacement fluid is used. For convenience, the locking system can also be one that enables the provision of a “child-proof” cap on the refill bottle. This “lock-and-key” type of system thus provides highly desirable safety features. There are a variety of ways to design such lock and key sealing systems.

Care must be taken, however, to prevent the system from making the filling and sealing operation too difficult. If desired, the lock and key can be integral to the sealing mechanism. However, for the purpose of ensuring that the correct recharge or refill is used, the interlocking pieces can be separate from the sealing system. E.g., the shroud and the container could be designed for compatibility. In this way, the unique design of the container alone could provide the requisite assurance that the proper recharge/refill is used.

Examples of threaded closures and bayonet systems can be found in U.S. Pat. 4,781,311, Nov. 1, 1988 (Angular Positioned Trigger Sprayer with Selective Snap-Screw Container Connection, Clorox), U.S. Pat. No. 5,560,505, Oct. 1, 1996 (Container and Stopper Assembly Locked Together by Relative Rotation and Use Thereof, Cebal S A), and U.S. Pat. No. 5,725,132, Mar. 10, 1998 (Dispenser with Snap-Fit Container Connection, Centico International). All of said patents are incorporated herein by reference.

The present invention also relates to an article of manufacture comprising a coating composition for use in spraying and/or misting an entire hard surface or article in a manner such that excessive amounts of the coating composition are prevented from being released to the open environment, provided in association with instructions for use to ensure that the consumer applies at least an effective amount of nanoparticle system and/or coating composition, to provide the desired hard surface multi-use benefit.

Other coating compositions of the present invention for use to treat hard surfaces, such as dishware, in different steps of the automatic dishwashing process, e.g., pre-wash, wash cycle, rinse cycle, and drying cycle, can be packaged in association with instructions for how to use the coating composition to treat dishware correctly, in order to obtain the desirable hard surface coating results, viz. improved multi-use hard surface wetting and sheeting, quick drying, uniform drying, soil removal, self-cleaning, anti-spotting, anti-soil deposition, cleaner appearance, enhanced gloss, enhanced color, minor surface defect repair, improved smoothness, anti-hazing properties, modification of surface friction, release of actives, reduced damage to abrasion and improved transparency.

### Product With Instructions for Use

The present invention also encompasses the inclusion of instructions on the use of the coating compositions of the present invention with the packages containing the coating compositions herein or with other forms of advertising associated with the sale or use of the coating compositions. The instructions may be included in any manner typically used by consumer product manufacturing or supply companies. Examples include providing instructions on a label attached to the container holding the coating composition; on a sheet either attached to the container or accompanying it when purchased; or in advertisements, demonstrations, and/or other written or oral instructions which may be connected to the purchase or use of the coating compositions.

Specifically the instructions will include a description of the use of the coating composition, for instance, the recommended amount of composition to use in order to coat the hard surface or article the recommended amount of composition to apply to the hard surface; if spraying, soaking or rubbing is appropriate. The instructions may provide that the user is to allow the coating composition to dry without rinsing or agitating the same.

The coating compositions of the present invention are alternatively included in a product. The product alternatively comprises a hard surface coating composition in accordance with the present invention, and further comprises instructions for using the product to launder hard surfaces by contacting a hard surface in need of treatment with an effective amount of the coating composition such that the coating composition imparts one or more desired hard surface coating benefits to the hard surface.

The following examples are illustrative of the present invention, but are not meant to limit or otherwise define its scope. All parts, percentages and ratios used herein are expressed as percent weight unless otherwise specified.

The compositions and methods of the present invention can be used for domestic modification of hard surfaces, or for industrial modification of hard surfaces, such as in automotive and building component manufacturing.

### EXAMPLE(S)

The following provides several non-limiting examples of the present invention.

### Examples 1-14

Liquid coating compositions, according to the present invention, are as follows where the balance is water:

TABLE 1

| Example # | Nanoparticle (Wt %) | Surfactant (Wt %) |
|---|---|---|
| 1 | Nanoclay (0.1) | Neodol 91-6 (0.075) |
| 2 | Nanoclay (0.05) | Neodol 91-6 (0.075) |
| 3 | Nanoclay (0.05) | Silwet L-77 (0.025) |
| 4 | Nanoclay (0.1) | Q2-5211 (0.025) |
| 5 | Nanoclay (0.05) | Q2-5211 (0.025) |
| 6 | Nanoclay (0.03) | Q2-5211 (0.1) |
| 7 | Nanoclay (0.1) | Tergitol 15-S-9 (0.1) |
| 8 | Nanoclay (0.1) | Tergitol NP-9 (0.1) |
| 9 | Nanoclay (0.1) | Neodol 91-8 (0.075) |
| 10 | Nanoclay (0.1) | Component A (0.2) |
| 11 | Nanoclay (0.2) | Component A (0.2) |
| 12 | Nanoclay (0.1) | Component B (0.2) |
| 13 | Nanoclay (0.1)² | Neodol 91-6 (0.075) |
| 14 | Disperal P2 ™ (0.1)³ | Neodol 91-6 (0.075) |

1. Nanoclay can be any of the available synthetic hectorite clays, such as Laponite ™ available from Southern Clay Products, Inc. One preferred grade of Laponite ™ is Laponite B ™, a sodium magnesium lithium flurosilicate.
²One preferred grade of Laponite ™ for this example is Laponite RD ™.
³Disperal P2 ™ is boehmite alumina from Condea, Inc.

### Examples 15-18

In the following examples, dispersants are formulated with the nanoclay and surfactant to allow the hard surface coating composition to be made with tap water:

TABLE 2

| Example | Nanoparticle | | |
|---|---|---|---|
| # | (Wt %) | Surfactant (Wt %) | Dispersant (Wt %) |
| 15 | Nanoclay (0.1) | Neodol 91-6 (0.075) | Polyacrylate 4500 MW |
| | | | (0.02) |
| 16 | Nanoclay (0.1) | Neodol 91-6 (0.075) | Poly (acrylic/maleic)² |
| | | | (0.02) |
| 17 | Nanoclay (0.1) | Neodol 91-6 (0.075) | Polyacrylate 2000 MW |
| | | | (0.02) |
| 18 | Nanoclay (0.1) | Neodol 91-6 (0.075) | STPP (0.02) |

1. Nanoclay can be any of the available synthetic hectorite clays, such as Laponite B ™ from Southern Clay Products, Inc.
²MA:AA = 4:6, MW = 11,000.

### Examples 19-26

Liquid coating compositions, according to the present invention, where the balance is water, and where said coating composition can be applied to a surface, or optionally where the coating composition can be diluted with water to achieve a coating composition with 0.1% concentration of nanoparticles are as follows:

TABLE 3

| Example | Nanoparticle | | Dispersant |
|---|---|---|---|
| # | (Wt %) | Surfactant (Wt %) | (Wt %) |
| 19 | Nanoclay (1.6) | Q2-5211 (0.8) | None |
| 20 | Nanoclay (0.8) | Q2-5211 (0.4) | None |
| 21 | Nanoclay (0.8) | Neodol 91-6 (0.6) | None |
| 22 | Disperal P2 ™ (10) | Neodol 91-6 (7.5) | None |
| 23 | Nanoclay (5.0) | Neodol 91-6 (3.75) | Polyacrylate 4500 |
| | | | MW (1.0) |
| 24 | Nanoclay (5.0) | Neodol 91-6 (3.75) | Poly (acrylic/ |
| | | | maleic)³ (1.0) |
| 25 | Nanoclay (1.0) | Neodol 91-6 (0.75) | Polyacrylate 4500 |
| | | | MW (0.2) |
| 26 | Nanoclay (1.0) | Neodol 91-6 (0.75) | Polyacrylate 4500 |
| | | | MW (0.1) |

1. Nanoclay can be any of the available synthetic hectorite clays, such as Laponite ™ available from Southern Clay Products, Inc.
2. Disperal P2 ™ is boehmite alumina from Condea, Inc.
³MA:AA = 4:6, MW = 11,000.

The following examples 27 and 28 are compositions that can be actively cured to increase the durability of the hard surface coating. (It is, of course, also possible to actively cure compositions in the other examples provided herein.)

### Example 27

A composition comprising 68 grams of URECLEAR® clearcoat obtained from BASF Corporation of Southfield, Mich., USA is combined with 0.1 to 25 grams of a nanoclay, such as Laponite™, a synthetic hectorite clay obtained from Southern Clay Products, Inc. of Gonzales, Tex., USA. These two components are mixed under agitation, and 15 grams of methyl isoamylketone methyl-2-hexanone is added.

The clearcoat composition is sprayed wet-on-wet over a high solids basecoat onto electocoated primed automotive body panels. The panels are flashed at ambient temperatures for 10 minutes and then cured for 20 minutes at 270° F. (132.20° C.).

### Example 28

Automotive body panels are treated with 0.1% nanoclay/0.075% Neodol 91-6 surfactant using a Solo sprayer and air-dried vertically. Several panels are used and are cured at different temperatures. Panels are heated in an oven at the temperatures specified in Table 1 for 25 min., and then allowed to cool. Post-heat performance is assessed, panels are scrubbed (Sheen Wet Abrasion Scrub Tester, 500 g total wt., sponges saturated with dilute DAWN® dishwashing liquid solution), and performance is reassessed. Contact angle measurements are taken before heating, after heating, and after scrubbing. A Miniscan XE with C/2° illuminant (Hunter Associates Laboratory, Inc., Reston, Va., USA) is used to measure panel color (CIE L*a*b* color scale) after heating. Some panels are treated with thionin cationic dye (500 ppm) to visually assess the coating composition's longevity.

TABLE 4
Heating Profile - Performance and Removability ^{a}

| | | | Sheeting/Curtaining |
|---|---|---|---|
| | | Performance | Lasts Through: |
| | | After Heating | (0, 10, 50, 100, 500 |
| Temperature (° C.) | | (25 min.) | scrubs) |
| 22 | Ambient | Sheeting | <10 scrubs |
| 60 | Baking temp used in | Sheeting | <10 scrubs |
| | aftermarket coating | | |
| | applications | | |
| 80-110 | Low end baking temp | Curtaining | <50 scrubs |
| | used by Original | | |
| | equipment manufacturers | | |
| | (OEM's) (80° C.) | | |
| 135 | | Curtaining | <100 scrubs |
| 148 | | Curtaining | 500 scrubs |
| 160 | High end baking temp | Curtaining | 500 scrubs |
| | used by OEM's | | |

^{a} black panels, cured 3 days

### Examples 29-31

Granular, hard surface coating compositions, according to the present invention, which can be placed into the rinse aid cup of a dishwasher and dispensed through the rinse cycle for improved spotting filming benefits on dishware surfaces are as follows:

| | | % by weight | | |
|---|---|---|---|---|
| Component | | 29 | 30 | 31 |
| 1. | Plurafac RA30 | 35 | — | — |
| 2. | Citric Acid | 3 | — | — |
| 3. | Acusol 480 | 8 | — | — |
| 4. | Naxonate 45SC | 9 | — | — |
| 5. | DTPMP | 0.05 | — | — |
| 6. | Nanoclay | 0.005-2 | 0.005-2 | 0.005-2 |
| 7. | Ether capped | — | — | 0.01-1 |
| | poly(oxyalkylated) alcohol | | | |
| 8. | Ethanol | 7 | — | — |
| 9. | Perfume | 0.1 | — | — |
| 10. | Dye | 0.3 | — | — |
| 11. | Water | Balance | Balance | Balance |

1. Plurafac RA ™ is a surfactant from BASF.
2. Citric Acid used for pH control.
3. Acusol 480 ™ is a Rhom and Haas polymer.
4. Naxonate 45SC ™ is a hydrotrope for better formulatability.
5. DTPMP is a sequestering agent.
6. Nanoclay can be Laponite RD ™ or B ™ from Southern Clay Products.
7. Ether capped poly(oxyalkylated) alcohol acts as a nonionic wetting agent.
8. Ethanol is used for viscosity control.
9. Perfume and Dyes are optional.

### Examples 32 and 33

Liquid hard surface coating compositions, according to the present invention, which can be placed in a spray bottled and delivered as a spray-on formula for improved tough food soil release benefits on hard surfaces are as follows:

TABLE 5

% by weight

| Component | 32 | 33 |
|---|---|---|
| 1. Nanoclay | 0.005-2 | 0.005-2 |
| 2. Ether capped poly(oxyalkylated) alcohol | — | 0.01-1 |
| 3. Water | Balance | Balance |

1. Nanoclay can be any of the available synthetic hectorite clays, such as Laponite RD ™ or B ™ from Southern Clay Products, Inc.
2. Ether capped poly(oxyalkylated) alcohol acts as a nonionic wetting agent.
3. Water is used for balance.

The above coating compositions when applied to a hard surface, modify the hard surface to exhibit at least one of the following multi-use benefits consisting of improved hard surface: wetting and sheeting, quick drying, uniform drying, soil removal, self-cleaning, anti-spotting, anti-soil deposition, cleaner appearance, enhanced gloss, enhanced color, minor surface defect repair, smoothness, anti-hazing, modification of surface friction, release of actives, reduced damage to abrasion and transparency; as compared to a hard surface not treated with said hard surface coating composition.

In certain aspects, the hard surface coating has a transmittance to light of greater than or equal to about 75% measured according to the Transmittance Test. That is, in such an aspect, at least 75% of the incident light is transmitted through the hard surface coating, and 25% of the incident light will not be transmitted through the hard surface coating. In another aspect, the hard surface coating has a transparency such that the surface coated with the hard surface coating appears to the unaided human eye to be substantially unaltered in comparison to a surface that has not been coated with the hard surface coating.

It is also possible that the coatings described herein could potentially provide other benefits. It is believed, subject to confirmation, that the coatings described herein could potentially be useful in reducing drag on moving articles such as skis, and moving vehicles, such as automobiles, aircraft, watercraft, and the like, and in preventing the buildup of material on hard surfaces, such as preventing the buildup of ice on airplane wings and preventing the buildup of deposits such as scale on the inside of pipes in order to facilitate transport of fluids. One non-limiting example of a preventative purpose for the coating would be to utilize the coating composition in the nature of a drain cleaner. Such a composition can be poured into drain pipes to prevent the build up, or further build up, of deposits in the pipes.

In the case of any of the embodiments described in this detailed description, unless specified otherwise, the coating can be applied to the hard surface with or without the active curing step. It is understood that the active curing step is useful because it is believed to provide the coating with additional durability. The coatings described herein can be applied at any suitable time in the life of the hard surface including during or after manufacture of the hard surface, if it is a type of hard surface that is manufactured. The coating can also be applied during the life of the hard surface for protective purposes, preventative purposes, or any other purposes.

### Test Methods

Unless otherwise stated, all tests are performed under standard laboratory conditions (50% humidity and at 73° F. (23° C.)).

### Procedure for Measurement of Durability of Coating

### Procedure

1. Clean surface: 4″×12” auto panels are used as received with desired coating applied. If X-ray fluorescence (XRF) analysis is performed, panels are cut into 1″×1.5” (2.5×3.8 cm) rectangles, and cleaned by an ethanol rinse, followed by washing with DAWN® dishwashing liquid available from The Procter & Gamble Company of Cincinnati, Ohio, USA wash and deionized water rinse prior to use in the scrub test.

2. Apply product with hand pump sprayer until auto panel is completely wet, allow to air dry (2 hr. minimum).

3. Heat in oven for 25 min. (at desired temperature, e.g., one of the temperatures listed in Table 4), allow to cool to room temperature.

4. Measure contact angle.

5. Assess visual performance.

6. Perform scrub test.

7. Assess visual performance.

8. Measure contact angle once panel has dried.

9. Perform dye or XRF analysis.

Auto Panel Specifications: Test panels, primer and basecoat compositions are obtained from ACT Laboratories, Inc. (Hillsdale, Mich., USA). Their preparation method is as follows. The primer is sprayed on in two coats with no flash time between coats. Primer then flashes for 10 min. Substrates are baked in an oven for 30 min. at 265° F. (129° C.) (this temperature is the substrate, or panel, temperature). Film build range=0.9-1.1 mils (22.9 to 27.9 μm). Once the primer has cooled, the basecoat is applied in two coats with 60 sec. flash between coats, for a film build of 0.6-0.8 mils (15.2 to 20.3 μm). Basecoat is flashed for 2 min. before the URECLEAR® clearcoat is applied in two coats with 60 sec. flash between coats, to a film build of 1.9-2.1 mils (48.3 to 53.3 μm). The hard surface coating can be applied to the panels at any stage of the process as shown in FIG. 4. The panels are then flashed 20 min. prior to final oven bake: 10 min. at 180° F. (82° C.), then temperature is ramped up to 270° F. (132° C.) for 25 min. (substrate temperature).

### Visual Performance Assessment

The substrate is rinsed with water, while the panel is held at a 90° angle to horizontal, and the panel is judged to determine whether it exhibits sheeting, curtaining, or beading. “Sheeting” is when an even film of water covers the substrate, and slowly dries down without developing breaks in the film. “Curtaining” occurs when the water slowly pulls into the middle and drains off the substrate. Performance is judged to be “beading” when the water shows no affinity for the surface, and quickly runs off the substrate.

### Scrub Method for Measurement of Durability

Sheen Wet Abrasion Scrub Tester (Model 903PG. Sheen Instruments Ltd., Kingston, England) is fitted with 4-3.25″×1.5″×1.75″(8.25 cm×3.8 cm×4.4 cm) sponges saturated with 30 mL of 0.2% DAWN ® dishwashing liquid in deionized water with 10 grains per gallon added hardness (3:1 molar ratio Ca²⁺:Mg²⁺). The instrument is set to 30 cycles per minute, with 200 g weights on each of the 300 g carrier arms for a total of 500 g per carrier arm. Scrub levels: 0, 10, 50, 100, 500 scrubs.

### Contact Angle

Deionized water (25 μL) is pipetted onto the coated substrate, and contact angle is measured using a goniometer (NRL C.A.Model #100-00 115 from Reme-Hart Inc., Mountain Lakes, N.J., USA, with Olympus TGHM light source, Olympus Optical Co., Ltd., Japan) Three measurements are made and averaged for each sample tested.

The surfaces treated by the methods and with the compositions described herein can have a lower contact angle with water than the same surface which has not been treated as described herein.

### Dye Analysis

Only white surfaces can be used for this analysis. The surface is thoroughly rinsed with a solution of thionin cationic dye (500 ppm in deionized water), followed by a rinse with water to remove excess dye. An untreated surface of the same type is used as a control. The surface coverage of the synthetic hectorite coating can be assessed qualitatively by visual evaluation or by Hunter Miniscan XE measurements.

### X-Ray Fluorescence Analysis

X-Ray Fluorescence (XRF) is a nondestructive and noninvasive technique that assesses the concentration of elements in a sample or on the surface of a sample. The analysis is performed using a Phillips Analytical, 12 Michigan Dr. Natick, Mass. 01760, USA, PW2404 Sequential “4000W” X-Ray Spectrometer System, Serial No. DY735. The instrument settings and specifications for XRF analysis are set out in Table 6 below.

### Measurement Procedure

1) Calibration curves that relate instrument response to analyte concentration can be constructed by pipetting known concentrations of standards on the desired substrate. Standards are allowed to slowly dry before measurements are performed.

2) The standard or sample is assayed by placing the sample face down in a sample cup, loading the sample cup into the spectrometer, and initiating the data acquisition sequence. In the case of synthetic hectorite coatings, the element lines for Mg and Si are measured whereas the element line for Al is used for aluminum oxide coating.

3) Concentration for samples are determined from the calibration curve for standards.

TABLE 6
General conditions used on automobile surfaces

| Sample Chamber Environment | Vacuum |
|---|---|
| Collimator mask size | 16 mm |
| Collimator size | 700 μm |
| Volatage | 32 kV |
| Current | 125 mA |
| Detector type | Goniometer |
| Analysis time | 30 sec. |
| Element line assayed | Kal for desired element |
| Sample Spinner | On |
| Tube Type | Rhodium |

### Gravimetric Test for Determining Drying Time

The relative quickness of drying of a surface that has been wetted can be measured with and without treatment by the compositions disclosed herein, by simple gravimetric methods. A sample of material from which the surface is made is weighed. The sample is then wetted with water and allowed to dry. The sample with any water remaining thereon is weighed at various times throughout the drying process, and plotted in the form of a graph. When drying times are compared herein, they are compared in terms of weight of water remaining on the sample after a given time, which time used herein is ten minutes.

### Procedure for Comparison of Residue Formation on Surfaces

Surfaces to which this method is applicable include, but are not limited to, painted automotive panels, ceramic tiles, and glass.

Residue solutions tested include Morton Safe-T-Salt Rock Salt, Artificial Street Dirt in the form of a product known as HSW soil available from CHEM-PACK, Cincinnati, Ohio 45214 and tap water.

### Procedure

1. Clean surface: 1 ½″×2½″ painted automotive panels are used as received. The panels are washed with surfactant solution and rinsed with deionized water prior to use in the residue test. Bathroom tiles are cleaned by repeatedly wiping with isopropanol and rinsing with distilled water until rinse water beads or runs off tile in less than 5 seconds.

2. If gravimetric comparison of residue is to be performed, each surface (e.g. each automotive panel) is weighed before application of the residue solution (initial weight).

3. Apply nanoparticle hard surface coating product with hand pump sprayer until surface is completely wet, allow to air dry (4 hr. minimum).

4. A residue solution, which will result in residue upon drying, is applied with a hand pump sprayer until the surface is completely wet. The surface is allowed to air dry (6 hour minimum).

### Analysis

1. Visual assessment of residue formation on the surfaces is performed for example by counting the number of residue spots, grading for the amount of streaking and measurement of gloss/haze.

2. Gravimetric comparison of residue is performed where possible. Once the residue has dried completely, each surface is weighed (final weight) and the weight of the residue on the surface is determined by subtracting the initial weight of the surface from the final weight.

### Results

Residue is measured on five automotive panels for each treatment giving a Relative Standard Deviation ≦1. 1.

| Residue on Automotive Panels | Untreated Panel | Treated Panel |
|---|---|---|
| Salt¹ (mg) | 23.7 | 3.4 |
| Street dirt² (mg) | 1.64 | 0.46 |
| Number of salt spots | 141 | 24 |
| Number of artificial street dirt spots | 90 | 3 |

¹Morton Safe-T-Salt Rock salt
²Artificial Street Dirt as represented by HSW soil available from CHEM-PACK, Cincinnati, OH 45214

### Measurement of Gloss

The gloss of a surface can be measured using gloss meters and standard optical profilimetry methods.

### Transmittance Test

Transmittance is measured using AS™ method D 1003-00. Transmittance is expressed as a percentage that represents the amount of incident light that passes through the article that is tested.

### Viscosity Test

All measurements are performed with a Brookfield RVDV II+ rotational viscometer available from Brookfield Engineering Labs, Inc., Stoughton, Mass., USA. The recommended procedure is followed, with the following exceptions. The recommended procedure is varied by using a smaller vessel and removing the guard leg. The calibration is to be determined using a 600 ml low form griffin type beaker with Glycerin (1400 cp) and olive oil (80 cp) at 100 RPM. All subsequent measurements are performed in 50 ml beakers at 100 RPM with the appropriate spindle.

While particular embodiments of the subject invention have been described, it will be obvious to those skilled in the art that various changes and modifications of the subject invention can be made without departing from the spirit and scope of the invention. It is intended to cover, in the appended claims, all such modifications that are within the scope of the invention.

What is claimed is:

1. A hard surface coating composition for use in providing a hydrophilic coating on a surface, said hard surface coating composition comprising:
a) a surface modifying agent comprising a plurality of non-photoactive nanoparticles, said nanoparticles being present in an amount effective to provide a residual hydrophilic coating on a surface;
b) a carrier, at least some of which is aqueous, and at least some of said aqueous carrier being purified; and
c) less than about 10% by weight of other ingredients, wherein said coating composition is non-thixotropic.

2. The hard surface coating composition of claim 1 which is a liquid when it is in a state of rest.

3. The hard surface coating composition of claim 2 wherein the effective amount of non-photoactive nanoparticles is less than or equal to about 1% by weight of said composition.

4. The hard surface coating composition of claim 1 comprising less than or equal to about 5% by weight of said other ingredients.

5. The hard surface coating composition of claim 1 which is substantially free of polymers.

6. The coating composition according to claim 1 wherein said non-photoactive nanoparticles are selected from the group consisting of oxides, silicates, carbonates, hydroxides and mixtures thereof.

7. The coating composition according to claim 1 wherein said non-photoactive nanoparticles are selected from the groups consisting of:
a) inorganic metal oxides, natural clays, synthetic clays and mixtures thereof;
b) synthetic clays selected from the group consisting of kaolinite, montmorillinite/smectite, illite, variants and isomorphous substitutions of said synthetic clay groups and mixtures thereof;
c) synthetic clays selected from the group consisting of layered hydrous silicate, layered hydrous aluminum silicate, fluorosilicate, mica-montmorillonite, hydrotalcite, lithium magnesium silicate, lithium magnesium fluorosilicate and mixtures thereof.

8. The coating composition according to claim 7 wherein said synthetic clay is lithium magnesium silicate with the formula:
[Mg_{w}LiₓSi ₈O₂₀OH_{4-y}F_{y}]^{z-}
wherein w=3 to 6, x=0 to 3, y=0 to 4, z=12−2w−x, and the overall negative lattice charge is balanced by counter-ions.

9. The coating composition according to claim 8 wherein said lithium magnesium silicate is selected from the group consisting of fluorine substituted variants of lithium magnesium silicate and mixtures thereof.

10. The coating composition according to claim 1 wherein said hard surface is selected from the group consisting of fiberglass, plastics, metals, glass, dishware, ceramic, wood, stone, concrete, asphalt, mineral, painted and mixtures thereof.

11. The coating composition according to claim 1 wherein said surfactant is selected from the group consisting of anionic surfactants, cationic surfactants, nonionic surfactants, amphoteric surfactants, zwitterionic surfactants and mixtures thereof.

12. The coating composition according to claim 11 wherein said nonionic surfactant is selected from the group consisting of C_{9/11}EO₈-cyclohexyl acetal alkyl capped nonionic, C₁₁ EO₇-n-butyl acetal, C_{9/11}EO₈-2-ethylhexyl acetal, C₁₁EO₈-pyranyl, alcohol alkoxylate and mixtures thereof.

13. The coating composition according to claim 1 wherein said non-photoactive nanoparticles have a particle size distribution that falls within the range from about 1 nm to less than about 400 nm.

14. The coating composition according to claim 1 wherein said other ingredients comprise adjunct materials selected from the group consisting of photoactive inorganic metal oxides, organic solvents, surfactants, polymers, builders, bleaches, bleach activators, bleach catalysts, non-activated enzymes, enzyme stabilizing systems, chelants, optical brighteners, soil release polymers, wetting agents, dye transfer agents, dispersants, suds suppressors, dyes, perfumes, colorants, filler salts, hydrotropes, photoactivators, fluorescers, conditioners, hydrolyzable cosurfactants, perservatives, anti-oxidants, anti-shrinkage agents, germicides, fungicides, color speckles, silvercare, anti-tarnish and/or anti-corrosion agents, alkalinity sources, solubilizing agents, carriers, processing aids, pigments, and pH control agents.

15. The coating composition according to claim 1 wherein: said non-photoactive nanoparticles comprise sodium magnesium lithium flurosilicate in an amount less than or equal to about 0.2%; and said other ingredients comprise at least one wetting agent.

16. The coating composition according to claim 15 wherein said wetting agent comprises a low sudsing surfactant.

17. The coating composition according to claim 1 wherein an effective amount of photoactive inorganic metal oxides are combined with said effective amount of non-photoactive nanoparticles.

18. A hard surface coating composition comprising:
a) a plurality of non-photoactive nanoparticles in an amount effective to modify the characteristics of a surface, said amount being less than about 5% by weight of the composition;
b) a carrier, at least some of which is aqueous, and at least some of said aqueous carrier being purified;
c) optionally a surfactant; and
d) optionally one or more adjunct ingredients;
wherein said coating composition is capable of modifying a hard surface to provide at least one of the following multi-use benefits comprising improved: increased speed of drying, cleaner appearance, enhanced gloss, smoothness, and reduced damage to abrasion and transparency; as compared to the same hard surface not treated with said hard surface coating composition.

19. The hard surface coating composition of claim 18 wherein said coating composition is also capable of modifying a hard surface to provide anti-spotting and anti-hazing.

20. A method of forming a substantially clear coating on a hard surface, said method comprising:
locating a rigid article having a hard surface;
applying a composition to the hard surface, said composition comprising:
a) a surface modifying agent comprising a plurality of non-photoactive nanoparticles, said nanoparticles being present in an amount effective to provide a coating on the surface, said amount being less than or equal to about 25 micrograms of nanoparticles per cm² of the surface;
b) a carrier, at least some of which is aqueous, and at least some of said aqueous carrier being purified;
c) optionally a surfactant; and
d) optionally one or more adjunct ingredients;
allowing said composition to dry without rinsing or agitating the same so that a substantially clear, hydrophilic coating is formed on said hard surface.

21. The method of claim 20 wherein the effective amount of non-photoactive nanoparticles is less than about 5% by weight of said composition.

22. The method of claim 20 wherein said nanoparticles form more than one layer on said hard surface, and at least one of said more than one layer of said hard surface coating is strippable.

23. The method of claim 20 wherein after drying, the hydrophilicity of said hard surface coating endures more than one rinse.

24. A method of modifying a hard surface to provide said hard surface with multiple modified properties, said method comprising:
locating a rigid article having a hard surface;
applying a multiple benefit providing material for coating a hard surface to the hard surface, said material comprising:
a) an effective amount of non-photoactive nanoparticles;
b) a suitable carrier medium;
c) optionally a surfactant; and
d) optionally one or more adjunct ingredients; and
allowing said material to cure on said hard surface without rinsing or agitating said material to form a hard surface coating thereon which forms a residual hydrophilic exterior on said hard surface that provides said hard surface with two or more modified properties.

25. The method of claim 1 wherein said two or more modified properties are selected from the following improved properties: wetting and sheeting, quick drying, uniform drying, soil removal, self-cleaning, anti-spotting, anti-soil deposition, cleaner appearance, enhanced gloss, enhanced color, minor surface defect repair, smoothness, anti-hazing, modification of surface friction, release of actives, reduced damage to abrasion and transparency; as compared to a hard surface not treated with said material.

26. A method of modifying a surface to improve the ability of the surface to dry after the surface has been wetted, said method comprising:
locating an article having a surface, wherein when said surface is untreated, said surface will have a first amount of water remaining thereon ten minutes after said surface has been wetted and allowed to begin drying;
applying a composition to said surface, said composition comprising:
a) a surface modifying agent comprising a plurality of non-photoactive nanoparticles, said nanoparticles being present in an amount effective to improve the ability of a surface to dry after said composition has been applied thereto;
b) a suitable carrier medium;
c) optionally a surfactant; and
d) optionally one or more adjunct ingredients,
allowing said composition to dry without rinsing or agitating the same, wherein after said composition has dried on said surface, said surface is wetted it has a second amount of water remaining thereon ten minutes after said surface has been wetted and allowed to begin drying, wherein said second amount of water remaining on said treated surface is less than the first amount of water remaining on said untreated surface.

27. The method of claim 26 wherein the treated surface has a lower contact angle with water than the untreated surface.

28. A process for providing an article having a hard surface with an improved ability to have soil deposited thereon to thereafter be removed from said surface, said process comprising:
(a) locating an article having a surface;
(b) washing the surface of said article;
(c) optionally rinsing the surface of said article;
(d) coating the surface of said article with a coating composition comprising a plurality of non-photoactive nanoparticles, said nonoparticles being present in an amount effective to provide a coating on said surface, wherein the amount of said nanoparticles applied to said surface is less than about 5% by weight of said composition in the form in which it is applied to said surface whether it be diluted or undiluted; and
(e) allowing said coating composition to dry without rinsing or agitating the same so that said nanoparticles in said coating composition deposit onto the surface of said article, and at least some of said nanoparticles remain on said surface.

29. The process of claim 28 wherein said nanoparticles deposited on said surface form a durable coating that endures more than one rinsing.

30. The process of claim 28 wherein said coating forms at least one layer of nanoparticles.

31. The process of claim 28 wherein said coating forms multiple layers of nanoparticles.

32. The process of claim 31 wherein at least one of said multiple layers is strippable.

33. The process of claim 30 wherein said at least one layer is hydrophilic.

34. The process of claim 33 wherein said hydrophilicity provides said layer with resistance to soiling by hydrophobic types of soil.

35. The process of claim 28 further comprising a step (f) of exposing the surface to periodic rinsing with water.

36. The process of claim 28 wherein said surface has a cleaner appearance after the process has been performed than a similar surface which has not been coated with said coating composition.

37. A method of increasing the smoothness of a surface of an article, said method comprising:
locating an article having a surface, said surface having at least one irregularity therein;
coating at least a portion of the surface of said substrate containing said at least one irregularity with a coating composition, said coating comprising a plurality of non-photoactive nanoparticles; and
allowing said coating composition to dry without rinsing or agitating the same so that at least some of said nanoparticles in said coating composition at least partially fill said at least one surface irregularity to increase the smoothness of the surface of said substrate.

38. The method of claim 37 wherein said surface has an initial gloss before said method is performed and a final gloss after said method is performed, and said final gloss is higher than said initial gloss.

39. The method of claim 37 wherein said surface of the article reflects colored light to a greater extent after the method has been performed than said surface before it has been coated with said coating composition.

40. The method of claim 37 wherein said surface has an initial coefficient of friction with a second material before said method is performed, and a second coefficient of friction with the second material after the method has been performed, and said second coefficient of friction is lower than said first coefficient of friction.

41. The method of claim 40 wherein said article is of a type that moves, and said second material is air or water.

42. The method of claim 40 wherein said article is of a type that is stationary, and said second material moves relative to said article.

43. The method of claim 37 wherein the surface of the article has defects therein, and the method repairs at least some of said defects in said surface.

44. A method of forming a transparent, protective coating on a hard surface, said method comprising:
locating a rigid substrate with a hard surface;
coating the surface of said substrate with a hard surface coating composition, said hard surface coating comprising a plurality of non-photoactive nanoparticles, wherein said non-photoactive nanoparticles comprise sodium magnesium lithium flurosilicate; and
allowing said coating composition to dry without rinsing or agitating the same so that at least some of said nanoparticles in said coating composition form a transparent, protective coating on said hard surface.

45. The method of claim 44 wherein said transparent, protective coating protects said hard surface from damage due to abrasion.

46. A method for cleaning the surface of an article and applying a coating to said surface, said method comprising:
(a) locating an article having a surface to be cleaned;
(b) washing the surface of said article;
(c) rinsing the surface of said article;
(d) coating the surface of said article with a coating composition comprising a plurality of non-photoactive nanoparticles; and
(e) allowing said coating composition to dry without rinsing or agitating the same so that at least some of said nanoparticles in said coating composition deposit onto the surface of said article.

47. A method according to one of claims 20 or 46 wherein said non-photoactive nanoparticles are of a type that form a substantially complete coating on said surface.

48. A method according to one of claims 20 or 46 wherein said non-photoactive nanoparticles comprise sodium magnesium lithium flurosilicate in an amount less than or equal to about 0.2%, and said composition further comprises at least one wetting agent.

49. A method according to claim 20 or 46 wherein said wetting agent has a contact angle with water of less than or equal to about 20°.

50. A method according to one of claims 20 or 46 wherein said wetting agent comprises a low sudsing surfactant.

51. The method of claim 46 wherein the step (c) of rinsing the surface of the article comprises rinsing the surface with at least some purified water.

52. The method of claim 46 wherein the coating composition applied in step (d) further comprises water.

53. The method of claim 46 wherein the nanoparticles that deposit onto the surface of said article form a residual hydrophilic surface.

54. The method of claim 46 wherein after said coating composition ha s dried, at least some of said nanoparticles remain on said surface after said surface has been contacted with water.

55. A method for modifying a hard surface to increase the receptivity of said hard surface to the subsequent application of a substance, said method comprising:
locating a substrate with a surface;
depositing a surface modifying agent comprising a plurality of non-photoactive nanoparticles on the surface of said substrate, said nanoparticles having surfaces, wherein said surface with said nanoparticles thereon has increased receptivity to certain other substances relative to the surface of said substrate without said nanoparticles thereon; and
depositing one or more functionalized surface molecules onto the surfaces of at least some of said nanoparticles.

56. The method of claim 55 wherein said functionalized surface molecules exhibit properties selected from the group consisting of: hydrophilic, hydrophobic, and mixtures thereof.

57. The method of claim 55 wherein said functionalized surface molecules are selected from the groups consisting of:
a) monomeric materials, polymers, copolymers and mixtures thereof; wherein at least one segment or group of said monomeric material or polymer comprises functionality that serves to anchor or enhance adsorption on nanoparticle surfaces; and wherein at least one segment or group that serves to provide either hydrophilic or hydrophobic character to said polymer when adsorbed on a nanoparticle;
b) ethoxylated oligoamines, ethoxylated and quaternized oligoamines, ethoxylated, quaternized and sulfated oligoamines, ethoxylated and sulfated oligoamines, ethoxylated oligoamines which have been converted to sulfobetaine or betaine and mixtures thereof;
c) polycarboxylate copolymers with unsaturated monomers, polymethacrylates, polymaleates, polyfumarates, copolymers and mixtures thereof;
d) multi-valent inorganic salts consisting of Ca⁺², Mg⁺², Ba⁺², Al⁺³, Fe⁺², Fe⁺³, Cu⁺² and mixtures thereof; and wherein an appropriate anion is used to balance the charge of said nanoparticle; and
e) at least two different types of the foregoing functionalized surface molecules.

58. A composite structure with a hydrophilic surface, comprising:
a rigid substrate having a hard surface; and
a hard surface coating adhered to the surface of said substrate, said hard surface coating comprising a plurality of non-photoactive nanoparticles in an amount less than or equal to about 25 micrograms/cm² of the surface, said hard surface coating providing the composite structure with a hydrophilic surface.

59. The composite structure of claim 58 wherein said substrate is more rigid than a synthetic resin film which has a thickness of 0.1 mm.

60. The composite structure of claim 58 wherein the surface of said substrate is an exterior surface.

61. The composite structure according to claim 58 wherein said plurality of non-photoactive nanoparticles are arranged in the form of at least one layer.

62. The composite structure according to claim 58 wherein at least some of said non-photoactive nanoparticles remain on said surface after said surface is contacted with water.

63. An article of manufacture comprising an applicator comprising a spray dispenser, an immersion container, a hose spray dispenser attachment, a fabric or a porous article; said article of manufacture further comprising:
a) a coating composition according to claim 1, wherein said coating composition is contained within said applicator;
b) optionally a source of deionized water;
c) optionally a source of tap water; and
d) optionally a set of instructions in association with said spray dispenser comprising an instruction to dispense said coating composition from said spray dispenser onto a hard surface to modify said hard surface.

64. The article of manufacture of claim 63 wherein said spray dispenser is selected from the group consisting of: a diluting spray dispenser; a trigger spray device, and other manually operated spray dispensers, and non-manually operated spray dispensers, wherein said non-manually operated spray dispenser is selected from the group consisting of: powered sprayers; air aspirated sprayers; liquid aspirated sprayers; pneumatic sprayers; electrostatic sprayers; and nebulizer sprayers.

65. The article of manufacture of claim 63 in association with instructions for use, wherein said instructions for use direct the consumer to allow said coating composition to dry without rinsing or agitating the same.

66. A method according to claim 46 wherein said article is a vehicle, and said method is carried out at a facility for washing vehicles.
